(19) United States
(12) Patent Application Publication
(10) Pub. No.: US 2006/0031916 A1
(43) Pub. Date: Feb. 9, 2006

(54) Management and non-linear presentation of broadcasted or streamed multimedia content

(75) Inventors: David J. Colter, Sammamish, WA (US); Paul G. Allen, Seattle, WA (US); Ajay Arora, Seattle, WA (US); Robert E. Kaplan, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Vulcan Inc., Seattle, WA (US)

(21) Appl. No.: 11/119,356

(22) Filed: Apr. 29, 2005

Related U.S. Application Data
(60) Provisional application No. 60/566,756, filed on Apr. 30, 2004.

(51) Int. Cl. H04N 5/445; H04N 7/173; H04N 7/16; G06F 13/00

(52) U.S. Cl. 725/135; 725/86; 725/87; 725/45

(57) ABSTRACT

Methods and systems for presenting enhanced previously recorded broadcasted or streamed content are provided. Example embodiments provide an Enhanced Content Display System “ECDS,” which supports the management and presentation of previously recorded program content in a non-linear fashion and allows subscribers, using a variety of techniques, to specify which portions of programs or other content is of interest, thus enhancing their viewing experiences. In one embodiment, the ECDS includes an Intelligent Media Data Server (“IMDS”) that generates enhanced meta-data that are associated with portions of the delivered broadcasted content or video content. Using the generated enhanced meta-data, the ECDS helps subscribers locate, organize, and otherwise manage content that is delivered from a content distribution facility. This abstract is provided to comply with rules requiring an abstract, and it is submitted with the intention that it will not be used to interpret or limit the scope or meaning of the claims.

### TECHNICAL FIELD

The present invention relates to techniques for presenting content in a non-linear manner and, in particular, to techniques for managing and presenting previously recorded broadcasted or streamed multimedia content, such as television related content, in a non-linear accessible fashion.

### BACKGROUND

In the current world of television, movies, and related media systems, programming content is typically delivered via broadcast to, for example, a television or to a television or similar display connected to a cable network via a set-top box (“STB”); delivered “on demand” using Video on Demand (“VOD”) technologies; or delivered for recording for delayed viewing via a variety of devices, known generally as digital video recorders (“DVRs”). A DVR is also known as a personal video recorder (“PVR”), hard disk recorder (“HDR”), personal video station (“PVS”), or a personal TV receiver (“PTR”). DVRs may be integrated into a set-top box (a cable network's restricted access box) such as with Digeo's MOXI™ device or as a separate component connected to a set-top box. As used herein “programs” or “content” includes generally television programs, videos, presentations, conferences, movies, photos, or other video or audio content, such as that typically delivered by a “head-end” or other similar content distribution facility of, for example, a cable network. Customers generally subscribe to services offered by the head-end to obtain particular content. Some head-ends also provide interactive content and streamed content such as Internet content, as well as broadcast content.

In addition, electronic programming guides (“EPGs”) are often made available to aid a subscriber in selecting a desired program to currently view and/or to schedule one or more programs for delayed viewing. Using an EPG and a DVR, the subscriber can cause the desired program to be recorded and can then view the program at a more convenient time or location. However, the subscriber still needs to view the prerecorded program in the sequence in which it was recorded. Specifically, since broadcasted content or video content delivered “on demand” is delivered in a linear nature, the subscriber typically views the content from beginning to end, in a linear sequence, although the subscriber can use the standard controls of the DVR to “rewind” or “fast forward” to a desired spot in a prerecorded program. Thus even delayed viewing of previously delivered content can be somewhat slow and cumbersome.

Moreover, as the cable industry grows, the amount of content available for viewing is expanding at an ever-increasing rate. Thus, the ability of a subscriber to manage content of interest, especially broadcasted or other streamed content, has become increasingly difficult.

### BRIEF DESCRIPTION OF THE DRAWINGS

FIG. 1 is an overview flow diagram of the process used by an Enhanced Content Delivery System to present previously recorded program content in a non-linear manner.

FIG. 2 is a block diagram depicting an example Enhanced Content Delivery System.

FIG. 3 shows an example XML script that is generated for a particular broadcast for a News Browser application.

FIG. 4 is an example block diagram of a typical application built using an example Enhanced Content Delivery System.

FIG. 5 is an example block diagram of a general purpose computing system for practicing embodiments of an ECDS enabled application.

FIG. 6 is an example block diagram of the process of combining prerecorded programs with auxiliary information to generate non-linear (directly) accessible content.

FIG. 7 is an example of a MOXI™ user interface with an integrated News Browser application.

FIG. 8 is another example of a MOXI™ user interface with integrated applications.

FIGS. 9-25 illustrate various aspects of a prototype News Browser application integrated into a MOXI™ carded user interface.

FIG. 26 is an example block diagram of a MOXI™ carded interface modified to enable selection of other ECDS-enabled applications.

FIGS. 27-30 illustrate various aspects of a prototype Music Browser application integrated into a MOXI™ carded user interface.

FIGS. 31-33 illustrate various aspects of prototype auxiliary content integrated into a MOXI™ carded user interface.

FIGS. 34-37 illustrate various aspects of a prototype Video Personals Browser integrated into a MOXI™ carded user interface.

### DETAILED DESCRIPTION

Embodiments of the present invention provide enhanced computer- and network-based methods and systems for managing and presenting programs and other broadcasted or streamed content in a non-linear fashion and for managing related content in a way that makes “sense” to each subscriber. Example embodiments provide an Enhanced Content Delivery System (“ECDS”), which enables subscribers, using a variety of techniques, to specify which portions of programs or other content is of interest, thus enhancing their viewing experiences. For example, a user may desire to see only news segments or stories relating to certain topics but not others. As another example, the user may desire to see all such stories regardless of when they were broadcast or from what source.

The ECDS also includes an Intelligent Media Data Server (“IMDS”) that generates enhanced meta-data that is associated with portions of the broadcasted content or video content delivered “on demand.” Using the generated enhanced meta-data, the ECDS helps subscribers locate, organize, and otherwise manage content that is delivered from a content distribution facility, such as a head-end, to a set-top box (“STB”) for eventual storage, for example, on a DVR device. Once stored, the ECDS allows the user to manage such content via familiar search paradigms such as keyword searching or by matching portions of content that have particular attributes, across different broadcasts or streamed events.

In addition, the ECDS allows subscribers to relate auxiliary information to the particular content of interest. For example, when viewing a particular episode of a television (“TV”) show, the subscriber can also view recent interviews with one of the actors, see a photo gallery, hear the actor's favorite song, etc.

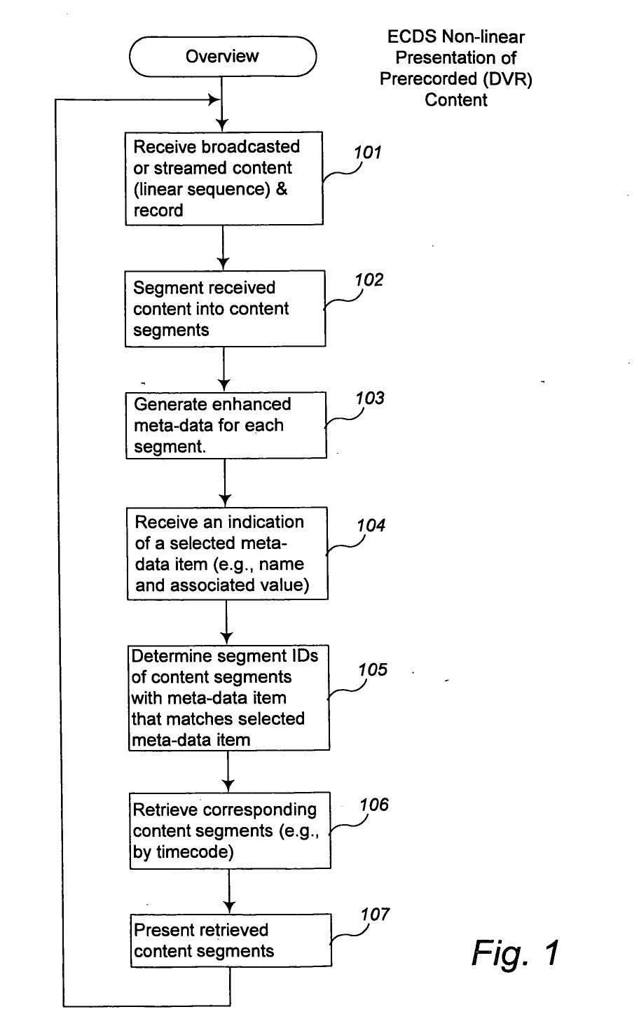

FIG. 1 is an overview flow diagram of the process used by an Enhanced Content Delivery System to present previously recorded program content in a non-linear manner. In step 101, the ECDS receives broadcasted or streamed content in a linear sequence and records the content in a memory associated with, for example, a DVR. In step 102, the ECDS segments the received content into one or more portions (content segments), as for example, performed by an IMDS component of the ECDS. In step 103, enhanced meta-data is generated for each such content segment, as for example, performed by the IMDS. In step 104, the ECDS receives, typically through a user interface, an indication of a meta-data item that the user wishes to use to organize or manage what prerecorded content is displayed. Note that the meta-data item may also be indicated programmatically, and that a user is not needed to practice the techniques of an ECDS. In step 105, the ECDS determines which content segments match the indicated meta-data item, for example, by determining segment identifiers of all of the content segments that contain a meta-data item with a value as designated by the user-indicated meta-data item. In step 106, the ECDS retrieves from the prerecorded content those content segments that match, for example, by using the determined segment identifier (directly or indirectly) to access the content segments. In step 107, the ECDS presents (e.g., plays, displays or otherwise presents) the retrieved content segments, and then the process continues. Each of the steps is described in the subsequent Figures and corresponding text.

The techniques of the ECDS and IMDS can be used with many different types of content deliverable by a content distribution facility, including broadcasted or streamed content and “video-on-demand” (“VOD” content). Although the examples, text, and figures, below may refer variously to VOD content, video content, streamed content, or generically “broadcasted content,” all such content is meant to be included or addressed unless specifically differentiated or excluded. Also, the terms “non-linear,” “selectively retrievable,” “random access,” “randomly accessible,” “via direct access,” “directly accessible,” “directly addressing,” and other similar terms and phrases can be used interchangeably to refer generally to the ability to access or otherwise manipulate a specific portion of content without sequentially playing through the content (in a linear fashion) from the beginning to a location of the desired specific portion.

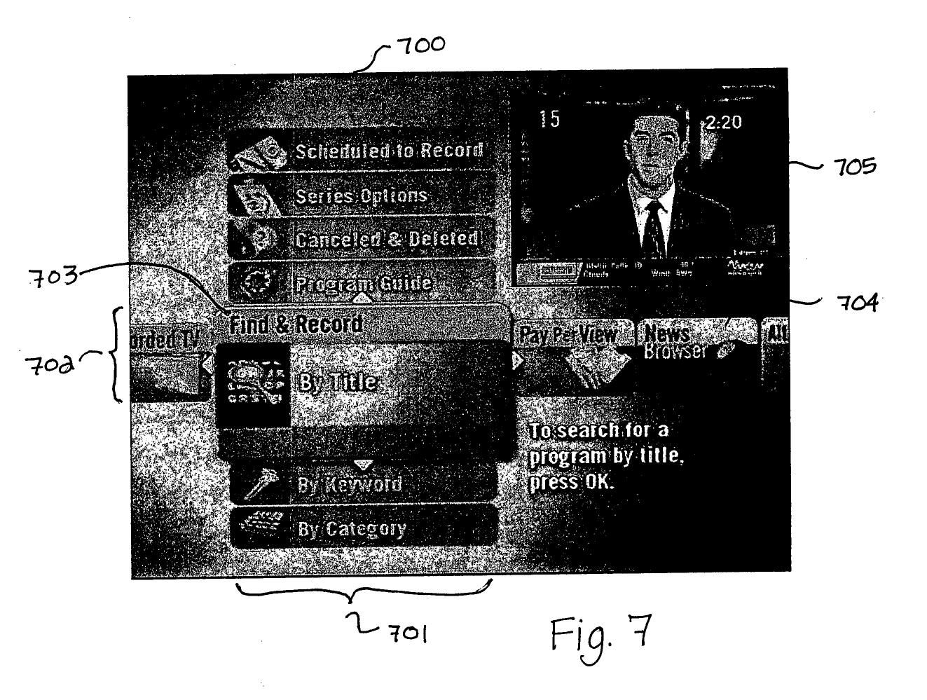

Example embodiments described herein provide applications, tools, data structures and other support to implement an Enhanced Content Delivery System. In general, the techniques of the ECDS and the IMDS are applicable to many different types of applications. Several prototype applications have been implemented to demonstrate the feasibility of these techniques and include a News Browser application, a Music Browser, other Auxiliary Content Browsers, and a Personal Ad application. Other embodiments of the described techniques may be used for other purposes, including other applications, and many of the techniques can be combined into applications relating to other subject areas and with other functionality. Several display pictures of the News Browser prototype and the other application prototypes listed above are described below with reference to FIGS. 7-37.

In one example embodiment, the Enhanced Content Delivery System comprises one or more functional components/modules that work together to deliver, manage, and present linear broadcasted or streamed content using non-linear techniques. For example, an ECDS may comprise an Intelligent Media Data Server (“IMDS”); one or more sources of content that are broadcasted, downloaded, or delivered (streamed) on demand to a DVR; a set-top box (“STB”) or similar computing system having a DVR, storage, and processing capability; and a presentation device, such as a television display. These components may be implemented in software or hardware or a combination of both. The IMDS is responsible for segmenting the content, generating and associating meta-data with the segments of content, and “training” the system to handle new types of content. The STB is responsible (typically through an application) for presenting an interface to allow the user to indicate desired content, and to retrieve and display portions of previously recorded content based upon the indicated desires and meta-data information.

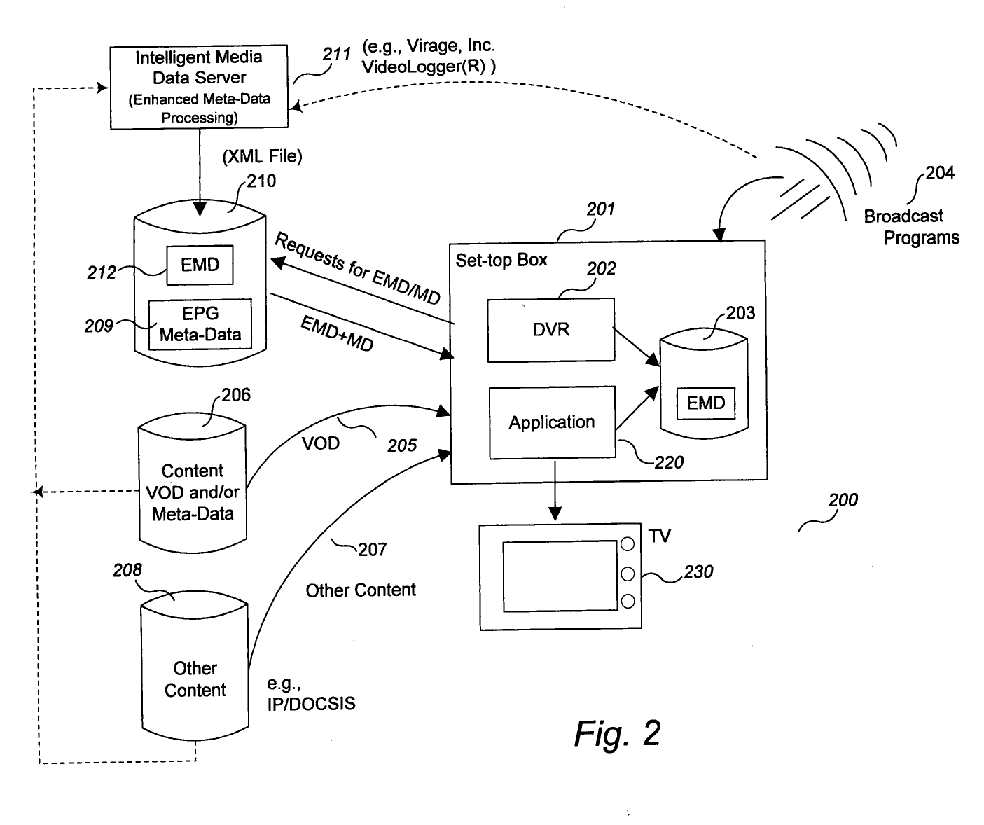

FIG. 2 is a block diagram depicting an example Enhanced Content Delivery System. In the Enhanced Content Delivery System 200 of FIG. 2, a set-top box (STB) 201 contains a DVR 202, a storage device 203 that receives content from one or more sources (e.g., content distribution facilities), and application code 220. Note that other configurations of the STB 201 are possible, including that one or both of the storage device 203 and application code 220 may be configured inside or outside of the DVR 202 yet still remain part of the STB 201. FIG. 2 depicts several sources of content, including broadcast program content 204, such as television programming from a cable network or satellite feed; video-on-demand (VOD) content 205 from a VOD server 206; other streamed or static content 207, for example, from an Internet portal 208 or a camera (not shown); and electronic programming guide (EPG) meta-data content 209 from EPG server 210. In addition, an Intelligent Media Data Server (IMDS) 211 generates enhanced meta-data (“EMD”) 212, which may also be forwarded to the STB 201 using the same or a different mechanism than that used to deliver the EPG meta-data 209 (e.g., the EPG server 210). The enhanced meta-data is meta-data that is associated with the program content on a segment-by-segment basis. Once the EMD 212 is forwarded to the STB 201, it is stored in storage device 203 (or other data repository). The application code 220 can manipulate the stored enhanced meta-data to selectively retrieve and present portions of stored content on display device 230, without playing through the linear sequence of the stored content from the beginning to the location of the desired portion. The various content and the various servers may be made available in the same or in different systems and by similar or disparate means, yet still achieve the techniques described herein. Other sources of content may be similarly incorporated.

In one embodiment, the IMDS 211 is implemented by incorporating commercially available technology, Virage, Inc.'s VideoLogger® SDK (software development kit), into a server that can generate meta-data for content as it is delivered for recording to the DVR 202. Other servers and/or logging systems for generating meta-data could be incorporated for use as the IMDS 211. In overview, the IMDS 211 is “trained” to recognize the structure of the content it is ingesting, and based upon that structure, generates enhanced meta-data that is associated with particular elements (e.g., segments) of that structure. The IMDS 211 can be “scheduled” to generate the enhanced meta-data in conjunction with the STB 201 receiving content according to a pre-scheduled event, such as recording a particular television broadcast.

In a typical configuration, the IMDS 211 receives content from the content distribution facilities at substantially the same time the content is delivered to the DVR 202 for pre-scheduled recording purposes. While the content is being recorded by the DVR 202, the IMDS 211 (e.g., the VideoLogger® based server) segments the content (virtually) by logically dividing it into content portions (segments) based upon parameters set as a result of training the IMDS 211 to recognize segments within that particular content. The IMDS 211 identifies each segment and generates enhanced meta-data appropriate to that segment. In one embodiment, the meta-data are generated in the form of XML scripts which are then forwarded to the EPG server 210 that delivers EPG data 209 to the set-top box 201. The EPG data 209 and enhanced meta-data 212 may be delivered upon request of the STB 201 all at once, at a specified time (such as after a scheduled show has been recorded), at some interval, upon specific request, or according to another arrangement.

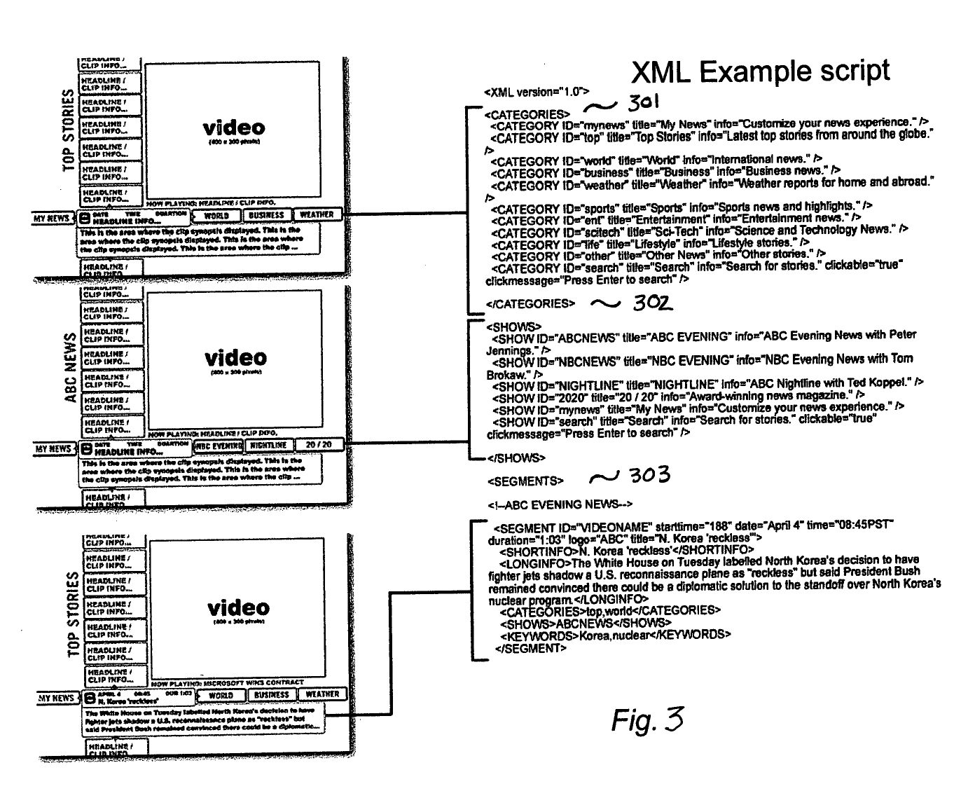

FIG. 3 shows an example XML script that is generated for a particular broadcast for a News Browser application. As can be observed from FIG. 3, the XML script used to display the interface and the content contains XML tags that define the meta-data for each segment. Other embodiments that may use or not use XML or any other scripted language are also contemplated for informing the STB 201 of meta-data information. For example, other file formats and scripting languages such as HTML, SMIL, PDF, text, etc. may be substituted.

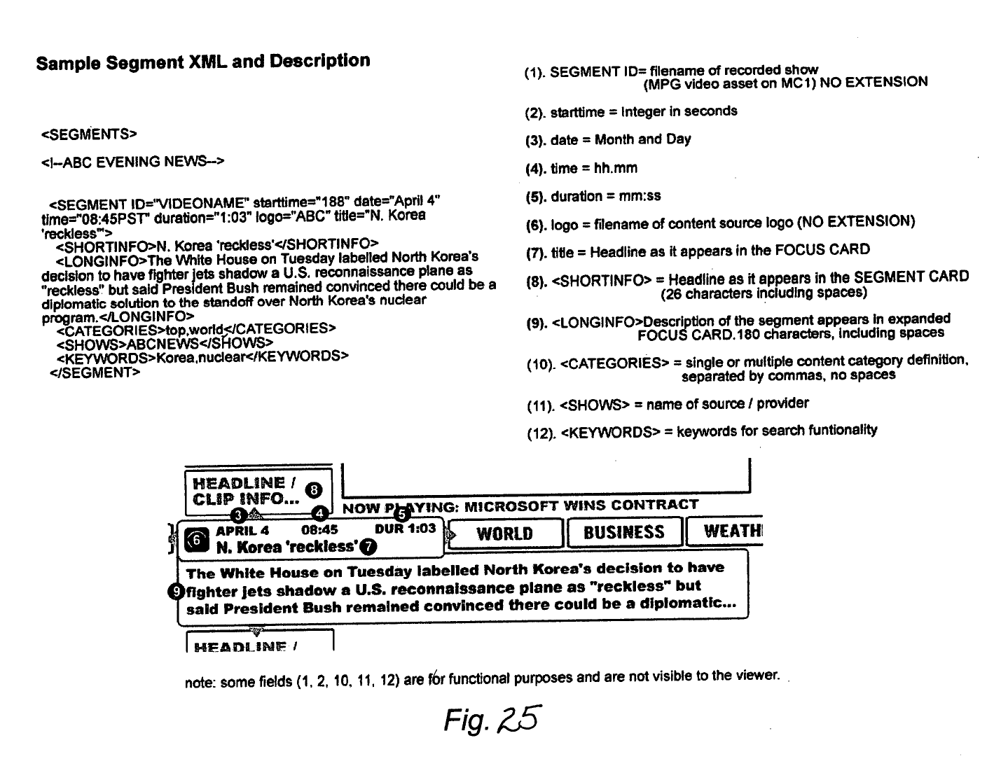

Example enhanced meta-data for a single segment of content may include such information as:
Segment identifier (e.g., the filename of recorded show (MPG video asset on a Moxi™ set-top box)
Start time (e.g., an integer in seconds)
Date (e.g., month and day)
Time (e.g., hh.mm)
Duration (e.g., mm:ss)
Logo (e.g., filename of content source logo)
Title (e.g., headline)
Short info (short description which may be used, for example, in a minimized form of an ECDS user interface)
Long info (longer description which may be used, for example, in an expanded form of an ECDS user interface)
Categories (e.g., single or multiple content category definition, separated by a separator character such as a comma)
Show Name (e.g., name of source or provider)
Keywords (e.g., terms for searching and filtering)
   A variety of other meta-data terms and definitions can be supported, including those that play sounds, cause other visuals to be displayed, etc. An example of how the meta-data are used to enhance the display in an example News Browser application is shown in FIG. 25.

In order to generate enhanced meta-data for broadcasted or VOD content and to (logically) segment such content into non-linear accessible (selectively retrievable) pieces, the IMDS 211 must be “trained” on specific content or types of content—that is the IMDS 211 must be informed regarding how to recognized the different segments that can be expected in the broadcasted or streamed content. For example, for the television news show “60 Minutes,” the IMDS 211 needs to be trained to understand that the show is delivered in standard parts, for example, an Introduction that overviews the three segments (stories) to be presented followed by a 20 minute presentation of each segment (including commercials). Training involves determining a structure for the particular content or category of content. Certain sounds and visuals, as well as timing, may be used to trigger the recognition of the start and end of particular portions of the structure. For example, certain key images (such as a clock) may appear and signal the arrival of each segment in the show “60 Minutes.”

In an embodiment of the IMDS 211 that incorporates the Virage, Inc. VideoLogger® technology, different modules (e.g., analysis plug-ins) are available to assist in analyzing patterns present in the content in order to determine “recognition” triggers. For example, output from a speech to text processor module, a facial recognizer module, and a module that detects frames of black can be studied to derive patterns in content. Once a set of patterns (i.e., a segmentation structure or characterization) is determined, then the recognition triggers derived from such patterns can be programmed into the VideoLogger® based server (or other IMDS 211) to be used to segment future content.

Once trained, the IMDS 211 can logically break up broadcasted or streamed content into segments that are accessible through an identifier associated with that particular segment, for example, a “timecode” or other time stamp. The time stamp may be associated with the segment itself (it may act as the identifier) or with the identifier of the segment, if an identifier other than the time stamp is used to identify the segment. Each segment can then be selectively retrieved from the prerecorded linear sequence of content by accessing the beginning of the segment that corresponds to the particular timecode that is associated with the (identifier of that) segment. Once retrieved, the ECDS can present the standalone segment in a non-linear fashion, without the remainder of the program content.

Thus, after the IMDS 211 has segmented one or more content programs and generated appropriate enhanced meta-data, the ECDS can search, filter, or otherwise organize prerecorded content based upon the stored meta-data instead of forcing a user to sequentially search different prerecorded programs to find what the user is looking for. In one embodiment, the filtering and searching capabilities incorporate EPG categories, such as title, genre, and actor, as well as additional enhanced capabilities based upon other segment defined meta-data, such as the meta-data types described above. One example enhanced capability is the ability to search prerecorded content based upon keywords. In embodiments in which the ECDS provides a user interface or other application with the ability to specify keywords, the user can quickly peruse an entire body of prerecorded content by searching for the presence of keywords in segments of the content.

The IMDS 211 can incorporate many different techniques for deriving keywords from a segment of content when it generates the enhanced meta-data 112 for segments of a particular program content. For example, a simple analysis of word frequency (using a speech to text processor) can be used to generate a set of n keywords for each segment. Alternatively, other heuristics such as the first line of text in a segment may be used to generate a set of keywords. Other rules of thumb and algorithms may be incorporated.

In one embodiment, the ECDS stores the enhanced meta-data information in a “table” that is used to map to various segments of content. This table may be as complex as a database with a database management system or as simple as a text file, or something in between. Table 1 below provides an abstraction of some of the information that may be maintained in such a map.

TABLE 1

| Segment ID | TimeCode | Date | Duration | . . . | Categories | Showname | Keywords |
|---|---|---|---|---|---|---|---|
| S0010234 | 00:01:20:00 | Apr. 24, 2004 | 10:17 | | News | 60 Minutes | Nuclear, . . . |
| S0010235 | 00:01:30:50 | Apr. 24, 2004 | 10:33 | | News | 60 Minutes | Energy, gas |
| S0010236 | 00:01:31:56 | Apr. 24, 2004 | 1:03 | | News | 60 Minutes | |
| S0010237 | . . . | Apr. 24, 2004 | 5:34 | | News | 60 Minutes | |
| S0010238 | | Apr. 24, 2004 | 2:05 | | News | 60 Minutes | |
| S0020100 | | Jun. 7, 2003 | 20:18 | | News | 20:20 | energy |
| S0020101 | | Jun. 7, 2003 | 20:18 | | News | 20:20 | |
| S0020102 | | Jun. 7, 2003 | 4:02 | | Entertnmt | Millionaire | Donald Trump |
| S0020103 | | Jun. 7, 2003 | 8:01 | | Entertnmt | Millionaire | |

The information in the map can include the enhanced meta-data generated by the IMDS as well as EPG information if desired. The table can be used by the ECDS to determine the segments that match one or more designated meta-data items and determine sufficient addressing information (such as a timecode) to allow the ECDS to directly access and retrieve the matching content segments from the linear prerecorded data.

When timecodes or other types of time stamps and duration are used to identify and retrieve a content segment from a linear sequence, one difficulty that may be encountered is that the timing information differs between the set-top box (or whichever device is receiving the program content from the content distribution facility) and the IMDS. Many techniques are possible for synchronizing (aligning) the timing information or computing adjustments for the time differences. For example, the start times can be aligned by presuming that the start time for the IMDS is accurate and determining from stored DVR data a substantially accurate time that the DVR started recording (often the DVR programs a slight earlier start to make sure the show is recorded properly). Some adjustments for the particular machine may need to be made. In one embodiment, an alignment procedure is available when the ECDS is configured to operate in a particular environment.

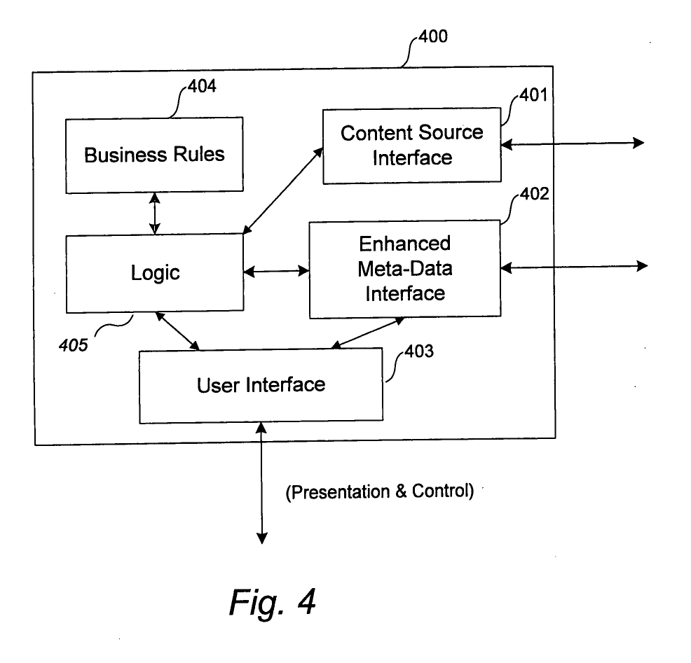

As mentioned, the ECDS can be used to build a variety of tools and applications. Each application built using the techniques of the ECDS generally includes a similar set of basic building blocks, or components. FIG. 4 is an example block diagram of a typical application built using an example Enhanced Content Delivery System. In FIG. 4, the Application 400 comprises a content source interface module 401 that interfaces to content distribution facilities to obtain content; an enhanced meta-data interface module 402 that interfaces to the EPG server or another enhanced meta-data server to obtain enhanced meta-data and potentially other related content; a user interface module 403; and a stored set of rules 404 and logic 405 (for example, business rules in a data base) that dictates how the meta-data maps to content segments and the flow of the user interface (“UI”). Other components may be present or organized in a different fashion yet equivalently carry out the functions and techniques described herein. Also, these components may reside in one or more computer-enabled devices, such as a personal computer attached to a DVR or a set-top box, or embedded within a DVR, or another configuration.

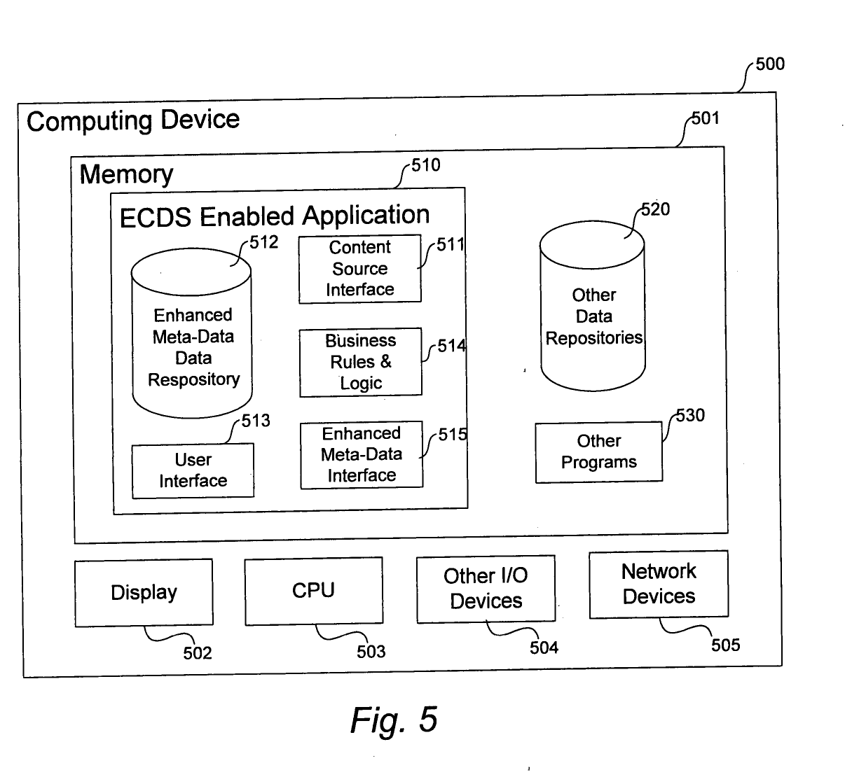

FIG. 5 is an example block diagram of a general purpose computing system for practicing embodiments of an ECDS enabled application. The general purpose computing system 500 may comprise one or more server and/or client computing systems and may span distributed locations. The computing system 500 may also comprise one or more set-top boxes and/or DVRs. In addition, each block shown may represent one or more such blocks as appropriate to a specific embodiment or may be combined with other blocks. Moreover, the various blocks of the ECDS-enabled application 510 may physically reside on one or more machines, which use standard interprocess communication mechanisms to communicate with each other.

In the embodiment shown, computing system 500 comprises a computer memory (“memory”) 501, a display 502, at least one Central Processing Unit (“CPU”) 503, and Input/Output devices 504. The ECDS-enabled application 510 is shown residing in memory 501. The components of the ECDS-enabled application 510 preferably execute on CPU 503 and manage the presentation of segments of content based upon enhanced meta-data, as described in previous figures. Other downloaded code 430 and potentially other data repositories 506, also reside in the memory 510, and preferably execute on one or more CPU's 430. In a typical embodiment, the ECDS-enabled application 510 includes one or more content source interface modules 511, one or more enhanced meta-data repositories 512, one or more business rules and logic modules 514, and a user interface 514. One or more of these modules may reside in a DVR.

In an example embodiment, components of the ECDS-enabled application 510 are implemented using standard programming techniques. The application may be coding using object-oriented, distributed, approaches or may be implemented using more monolithic programming techniques as well. In addition, programming interfaces to the data stored as part of the ECDS-enabled application can be available by standard means such as through C, C++, C#, and Java API and through scripting languages such as XML, or through web servers supporting such. The enhanced meta-data repository 512 may be implemented for scalability reasons as a database system rather than as a text file, however any method for storing such information may be used. In addition, the business rules and logic module 514 may be implemented as stored procedures, or methods attached to content segment “objects,” although other techniques are equally effective.

The ECDS-enabled application 510 may be implemented in a distributed environment that is comprised of multiple, even heterogeneous, computing systems, DVDs, set-top boxes, and networks. For example, in one embodiment, the content source interface module 511, the business rules and logic module 512, and the enhanced meta-data data repository 512 are all located in physically different computer systems. In another embodiment, various components of the ECDS-enabled application 510 are hosted each on a separate server machine and may be remotely located from the mapping tables which are stored in the enhanced meta-data data repository 512. Different configurations and locations of programs and data are contemplated for use with techniques of the present invention. In example embodiments, these components may execute concurrently and asynchronously; thus the components may communicate using well-known message passing techniques. Equivalent synchronous embodiments are also supported by an ECDS implementation. Also, other steps could be implemented for each routine, and in different orders, and in different routines, yet still achieve the functions of the ECDS.

As mentioned above, in addition to the ability to allow non-linear access to previously recorded content, the ECDS enables the association of “related” or auxiliary information with the recorded broadcasted or streamed data. This auxiliary information may be provided from any one of or in addition to the content sources shown in FIG. 2. The business rules and logic of FIG. 4 are then used to determine which auxiliary content to present along with the previously broadcasted or streamed video content. This capability allows programmed content to be more tailored to the needs of a particular user and potentially used to generate the retrieval of additional useful content, using a search engine-like paradigm, but applicable to a multitude of heterogeneous, multimedia data.

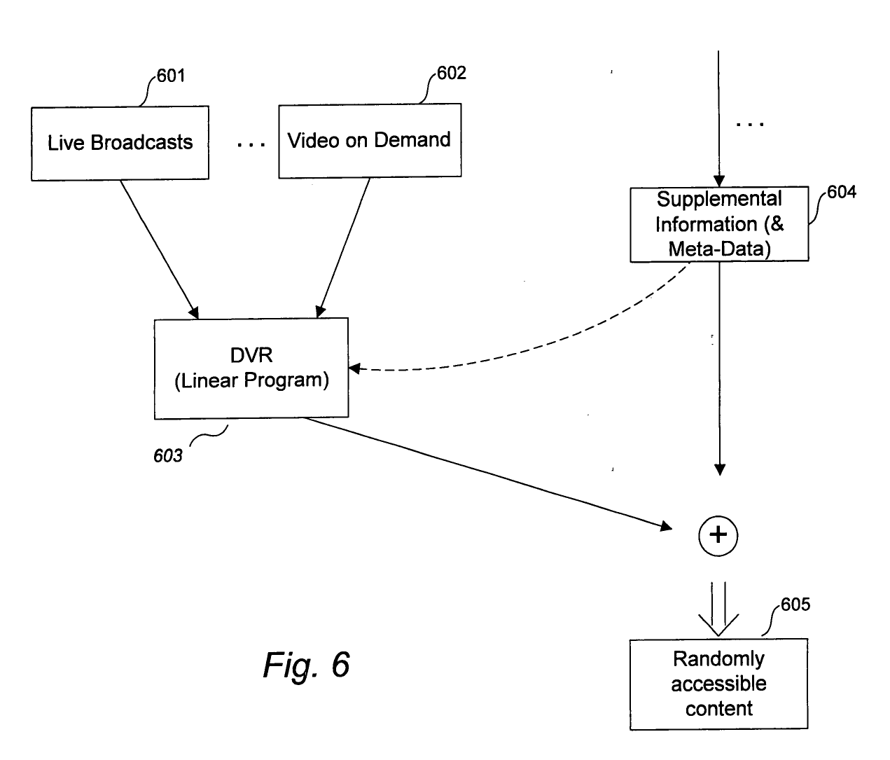

FIG. 6 is an example block diagram of the process of combining prerecorded programs with auxiliary information to generate non-linear (directly) accessible content. In FIG. 6, content is supplied via broadcast source 601, VOD source 602, etc. to a DVR 603, which is stored in a linear sequence by the DVR 603. Auxiliary content 604, for example supplemental content provided by the IMDS, is downloaded, potentially overnight, at prescheduled times or intervals, ala carte, or upon a subscription to the DVR 603, or onto another server that is accessible to an ECDS application at a future time. Auxiliary content 604 may include lots of other content in many different forms (as many as can be thought of and digitally transferred), including, for example, other prerecorded excerpts, interviews, audio excerpts, book reviews, etc. Once the auxiliary content 604 is made available, then the stored program content is accessible combined with the auxiliary content 604 in the segmented form 605 as described above.

Also, the ECDS offers a special speed controlled playback capability to be used with the playback of audio-video content. Specifically, a speed control module (not shown) is incorporated that allows both acceleration and deceleration of the video and audio data without noticeable degradation or change to either the video or the audio. For example, the video can be sped up without encountering a change in the pitch of the associated audio to a more high pitched (and potentially annoying) sound. Similarly, the video can be slowed down without encountering a change to a lower pitch of the associated audio. This speed control capability enhances the STB experience by further allowing a subscriber to customize his or her viewing experience.

In one example embodiment, an implementation of a publicly available algorithm, the SOLA algorithm (Synchronized Overlap Add Method) first described by Roucos and Wilgus, is incorporated to speed up or slow down the chipset in the MOXI™ set-top box to cause changes to the audio portion in conjunction with speed up of the video. Many different background references are available on SOLA, and the algorithm can be adjusted for the hardware, firmware, or software to be used. For example, background information is available in Arons, Barry, “Techniques, Perception, and Applications of Time-Compressed Speech,” in Proceedings of 1992 Converence, America Vioce I/O Society, September 1992, pp 169-177. As described by B. Arons:

Conceptually, the SOLA method consists of shifting the beginning of a new speech segment over the end of the preceding segment to find the point of highest cross-correlation. Once this point is found, the frames are overlapped and averaged together, as in the sampling method. This technique provides a locally optimal match between successive frames; combining the frames in this manner tends to preserve the time-dependent pitch, magnitude, and phase of a signal. The shifts do not accumulate since the target position of a window is independent of any previous shifts.

Other different algorithms could instead be employed. Note also that the audio needs to be synchronized with the accelerated/decelerated video. This function can be accomplished by computing the number of frames displayed per second, and checking to insure that the audio does not drift from that metric.

Embodiments of an example ECDS have been incorporated into a variety of prototype applications. In one embodiment, the prototype applications are built to operate with a MOXI™ set-top box/DVR produced by Digeo. The MOXI™ device includes a “carded” user interface, into which the set of prototype applications integrates. (Other methods of incorporating the prototype applications or other applications into a user interface of a DVR are also contemplated.) FIG. 7 is an example of a MOXI™ user interface with an integrated News Browser application. The MOXI™ interface 700 includes a set of horizontal cards 702 and a set of vertical cards 701, and a display area 705 for playing program content. The vertical cards 701, as typically used, specify options for a current selected card 703. So, for example, when the “Find & Record” option is selected from current card 703, the subscriber can choose to find a program to record by title, by keyword, by category, etc., which options are listed on the vertical cards 701. The horizontal cards 702 are typically used to navigate to different capabilities (for example, different applications). The current capabilities shown on horizontal cards 702 include a listing of what has been recorded on the television (“TV”), a Pay per View option, and a News Browser card 704 for accessing a News Browser application. Other applications can similarly be integrated into the MOXI™ interface through additional cards, or a single card with options listed on the vertical cards.

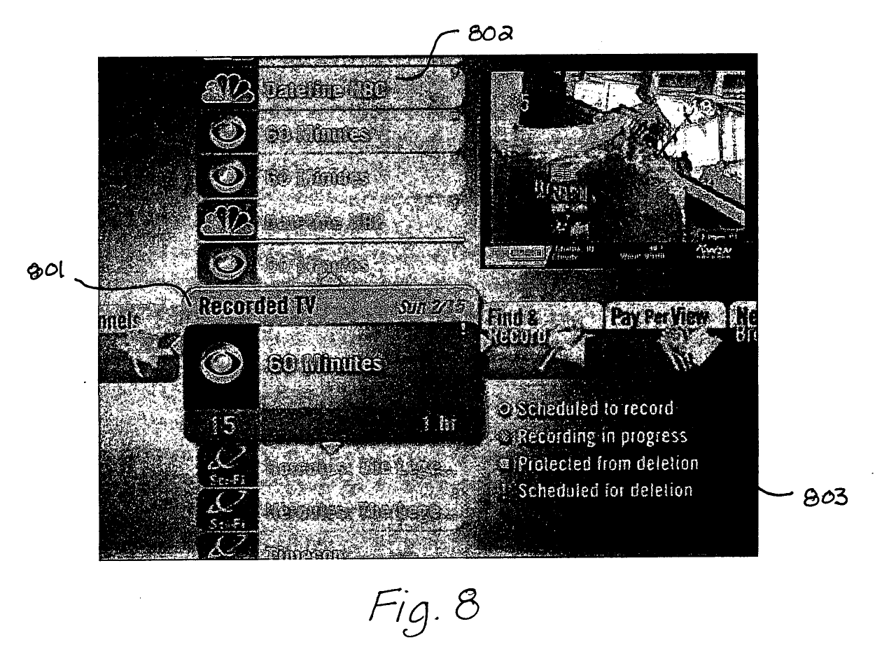

FIG. 8 is another example of a MOXI™ user interface with integrated applications. In this illustration, the current selected card is the “Recorded TV” card 801, which shows in vertical card list 802 the currently available shows that have been (or are in the process of being) recorded from television broadcasts. In addition, for each such show, the subscriber can determine a corresponding recording status 803, such as “scheduled to record, or recording in progress, etc.”

In an example embodiment, four different prototype applications that incorporate ECDS techniques have been implemented. These include: a News Browser, a Music Browser, an Auxiliary Content Browser, and a Personal Ad Browser. Each of these applications is described in turn.

News Browser

The News Browser application enables a subscriber (or other viewer) to watch desired segments of news programs in a delayed fashion, search for “stories” the same way a reader of a newspaper scans for stories of personal interest, and to track programs, topics, people, etc. of interest. In addition to displaying desired and target segments of particular programs organized in a way that makes sense to the viewer, the subscriber can also define the programs desired to be viewed based upon enhanced meta-data (not just based upon EPG data) and can search for particular stories/segments of interest using keywords. For example, a viewer might be looking for “that story I know I've seen in the last few days about new legislation involving nuclear waste.” Once a segment is displayed, the viewer can speed up or slow down playback using the acceleration/deceleration techniques described above.

In addition, the viewer might want to define particular organizations of news show segments other than the defaults provided by the News Browser application. In one embodiment, the application provides default news categories that include: Top Stories, Sports, Entertainment, World News, Business, Weather, Sci-Tech, Lifestyle, Other News, etc. Such personalized organization is defined as subcategories of a “MyNews” category. In one embodiment, keywords are used to define such user-defined news subcategories. Other meta-data and/or enhanced meta-data could also be used.

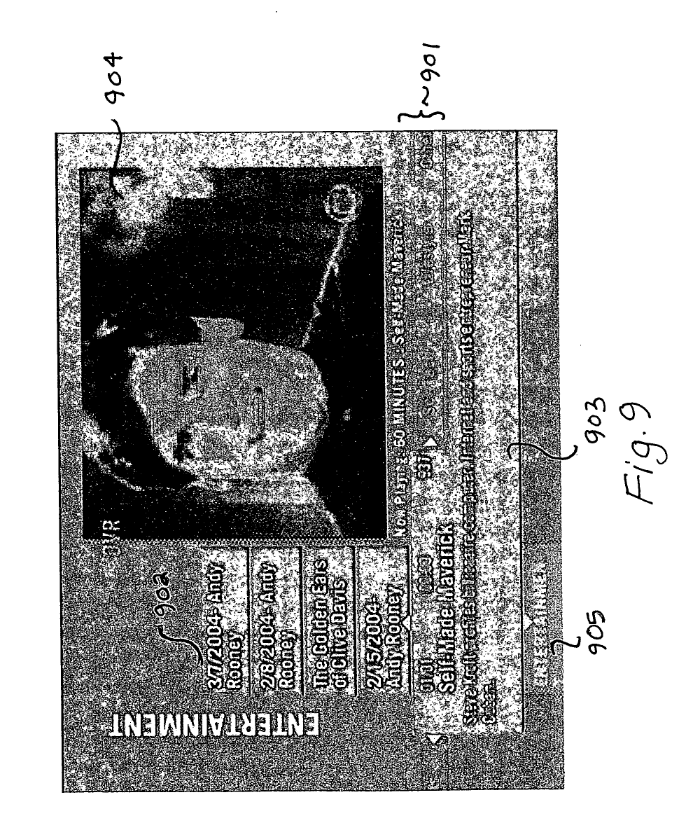

FIGS. 9-25 illustrate various aspects of a prototype News Browser application integrated into a MOXI™ carded user interface, as shown in FIGS. 7 and 8. FIG. 9 is an example display screen of a selected content segment in a News Browser application. The viewer has selected a current card 903 from the default Entertainment category 905 of horizontal card list 901. The current card 903 currently displays several fields of enhanced meta-data information including a short desription of the content segment. The display viewing area 904 displays the selected content segment. The vertical card list 902 shows the various available previously recorded program segments that are associated with meta-data that corresponds to the Entertainment category. The viewer can select between the various content segments by scrolling vertically using an input device to choose different cards from the vertical card list 902.

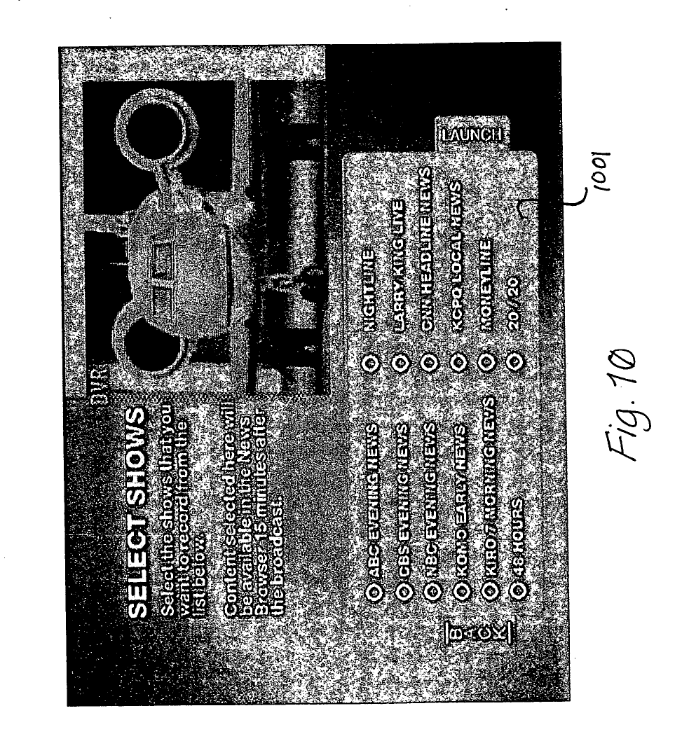

FIG. 10 is an example display screen illustrating one implementation of a user interface for selecting shows to be recorded for non-linear display and management. A list of the currently available shows (for which the IMDS is trained) is available from menu 1001. Once a show is selected, for example “20/20,” the ECDS automatically tracks, records, and generates meta-data for the desired show whenever it is broadcasted, as described with reference to FIGS. 1-6.

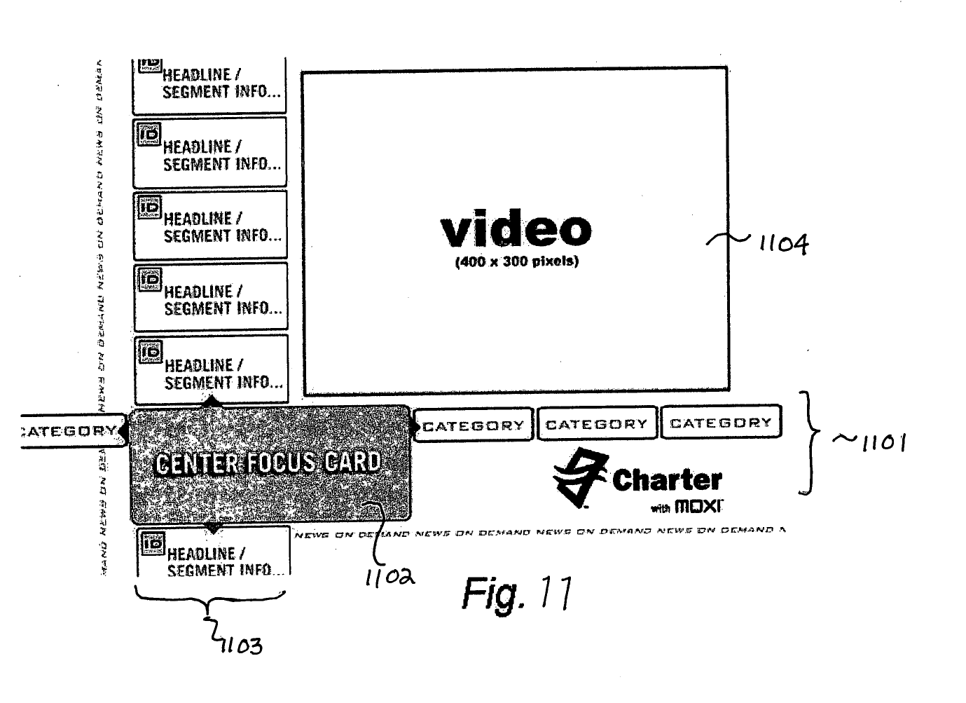

The general structure of a News Browser application is shown in FIG. 11. The viewer can easily browse, play and search for all available recorded news video (e.g., VOD CLIPS) by category. All available recorded news video clips are referred to as “news video clips,” “news segments,” or “news content” regardless of whether they have been recorded from a live broadcast or other means, such as video on demand. Similar to the Digeo Media Center's navigation model for the MOXI™ STB, the News Browser is based upon the following concepts:
center focus navigation
cards
horizontal axis
vertical axis
center card states

The MOXI™ interface organizes a plurality of cards according to a horizontal axis 1101 and a vertical axis 1103. The position of the center focus card 1102 is illustrated in FIG. 11. The viewer moves selectable objects (cards) into the center focus card 102 position to invoke actions. Cards are graphic representations of an individual category, feature, or news video clips. News video cards are indicated as HEADLINE/SEGMENT information or HEADLINE/CLIP information in the Figures described below that are not actually screen displays from the prototype. Cards are used to navigate among individual content categories, within categories, and to other functions available from the News Browser application. A video clip display area 1104 is available for playing selected content, which typically corresponds to the card in the center focus card 102 position.

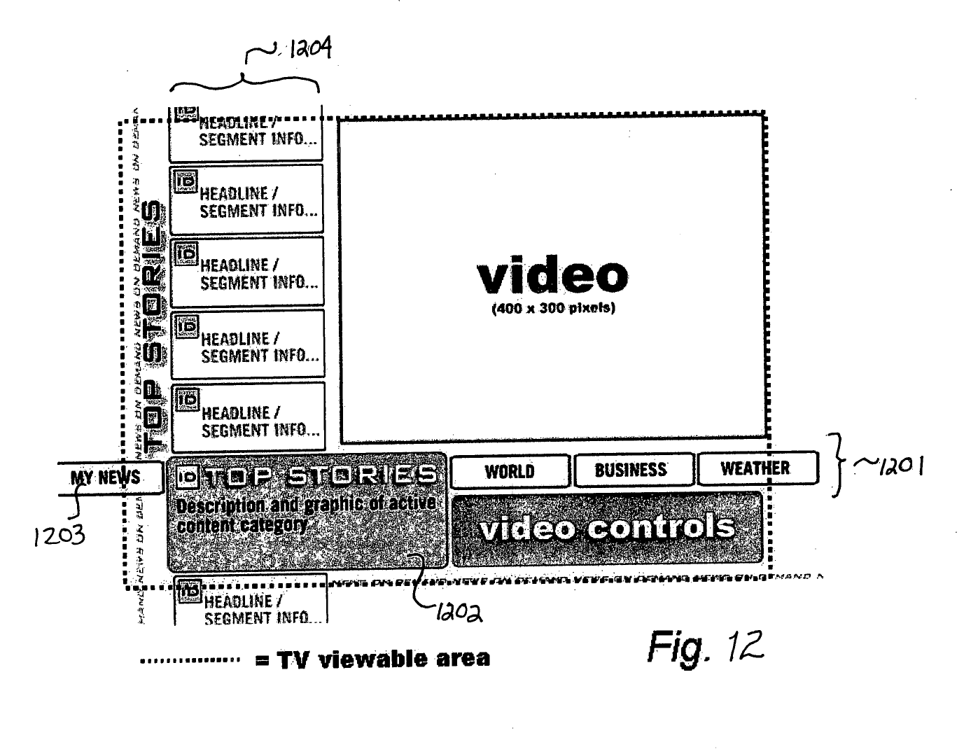

The News Browser horizontal axis is used to display news segment categories and application features. FIG. 12 is an example block diagram of the default categories and functions provided in a News Browser. The horizontal axis 1201 displays the default categories, including, for example:
MY NEWS (and KEYWORD CATEGORIES)
TOP STORIES
WORLD
BUSINESS
WEATHER
SPORTS
ENTERTAINMENT
SCI-TECH
LIFESTYLE
OTHER NEWS
   The horizontal axis 1201 also displays application functions such as a “Search” command and a Preferences function. The vertical axis 1204 displays the different choices available for selection by the viewer; for example, different content segments and feature choices.

The center card, for example center card 1202, is associated with several states and functions, appropriate to both axes since the center card is the intersection of the horizontal axis 1201 and the vertical axis 1204. The following states are supported:

Horizontal Axis

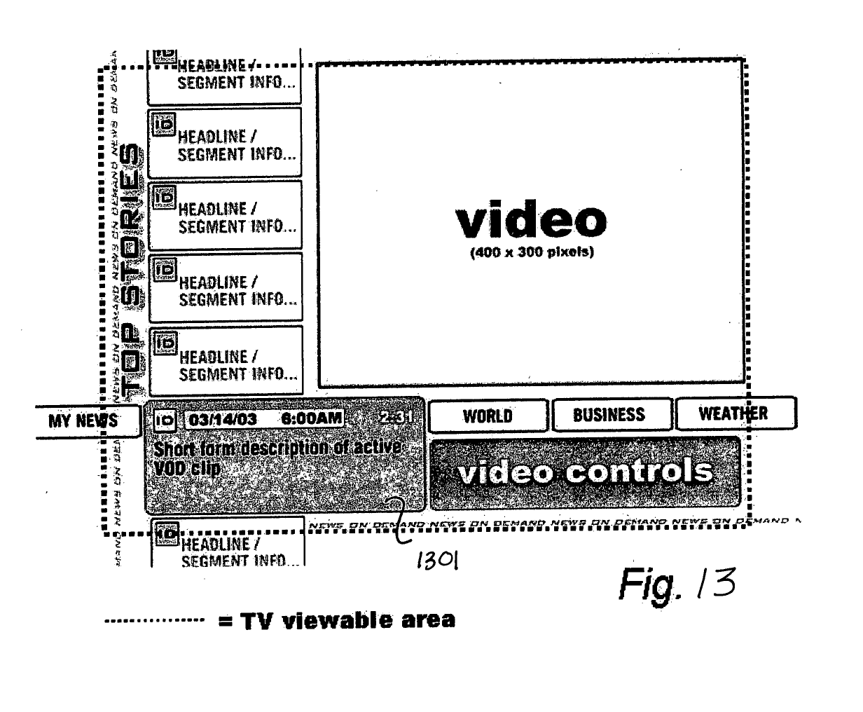

Default State: displays category identifier
Default Functions:
   Access CONFIGURE
   Access application FEATURES
      Vertical Axis
Resting State (Browsing): An expanded focus card displays news video segment information. The entire card becomes a PLAY BUTTON for the associated news video segment.
Resting Functions:
   Browse between news video segment information cards (e.g., VOD clips)
   Play highlighted news video segment in VIDEO WINDOW
   Perform actions/select highlighted option
Active State: A minimized focus card displays abbreviated information.
Active Functions:
   Play news video segment from start
   Revert to Browsing state FIG. 13 is an example block diagram illustrating a minimized (not expanded) focus card. A minimized focus card 1301 displays abbreviated news video segment information and displays a short description of a current video segment. Note that the enhanced meta-data is used to formulate the text for this card.

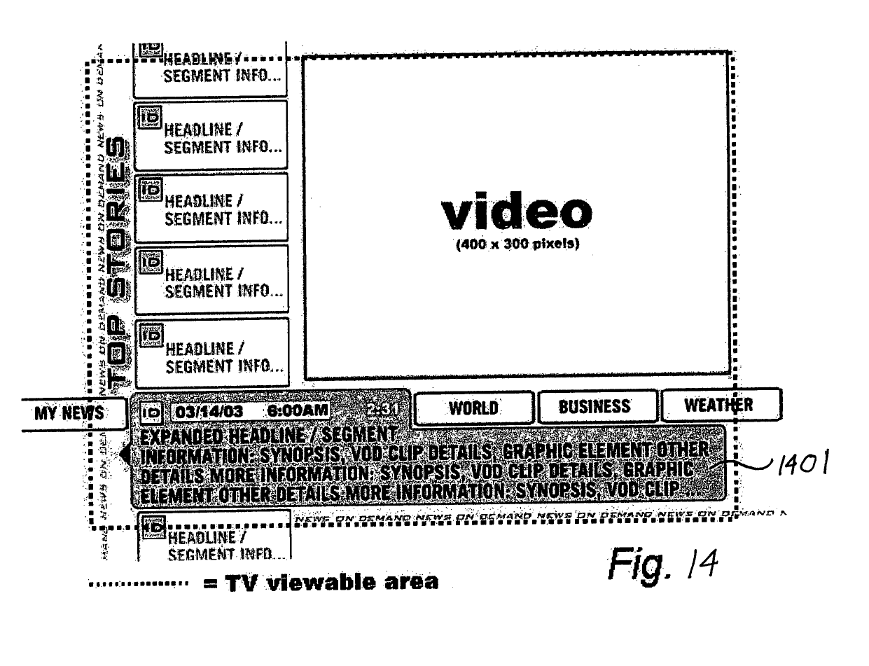

FIG. 14 is an example block diagram illustrating an expanded focus card. An expanded focus card 1401 displays a more in depth description of the current video segment.

As mentioned, a viewer can configure the News Browser to display content segments of interest to the viewer, by choosing categories, shows, or by specifying that the content contain certain user-defined keywords. In one embodiment, a new viewer is taken to the My News focus card and prompted to Configure the News Browser. In other embodiments, the new viewer can skip the configuration step and immediately start browsing content according to the default configured categories.

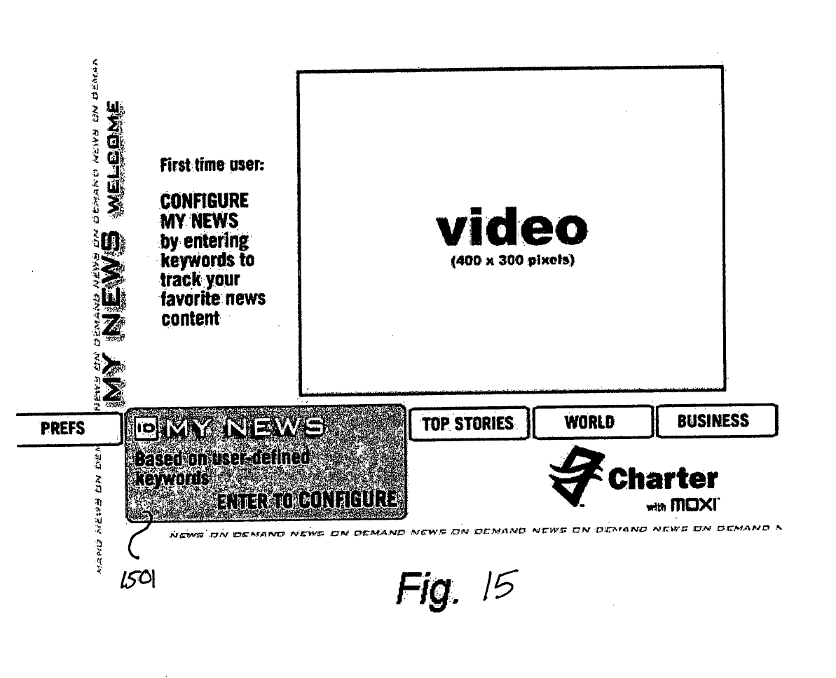

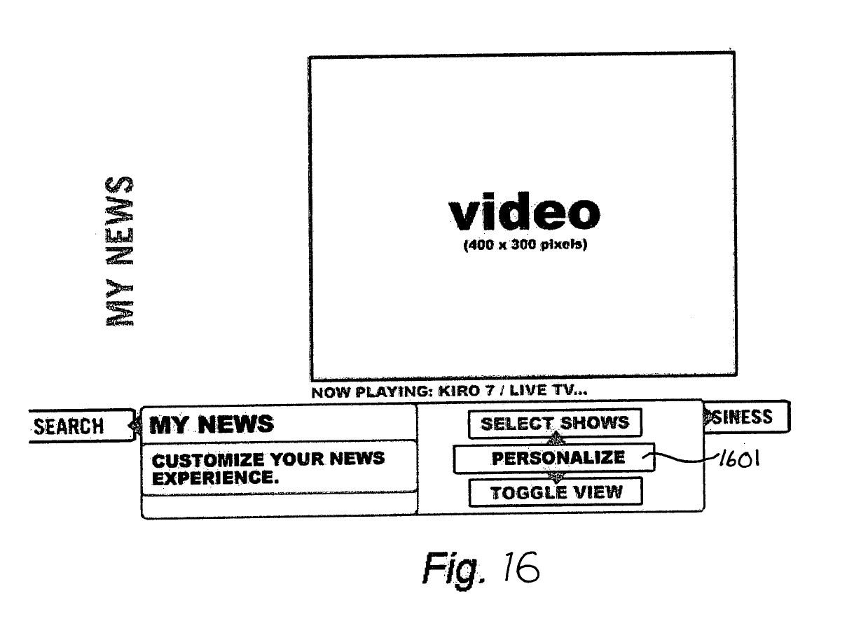

FIG. 15 is an example block diagram of the My News focus card. The viewer selects focus card 1501 to configure the My News category. The results of such configuration may determine additional categories/shows to be listed on the horizontal axis. FIG. 16 is an example block diagram illustrating that the viewer can select particular shows, toggle the view to select particular categories, or personalize (filter) the news segments displayed when the My News focus card is the center focus card.

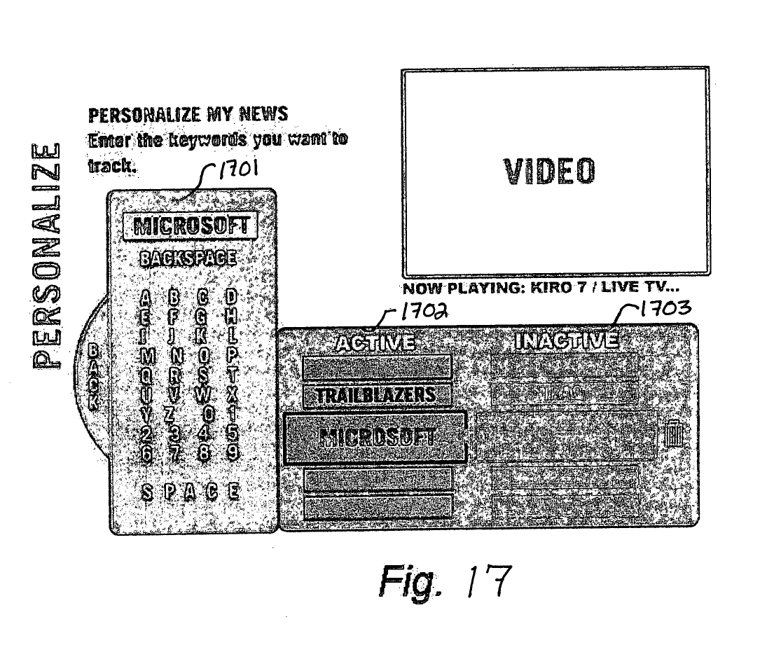

When the viewer selects “Personalize,” the user interface is shifted to a keyword entry navigation tool for entering keywords. FIG. 17 is an example display screen of a user interface for entering keywords on the STB. Keywords are entered (using an input device) according to keypad 1701 into either an active keyword list 1702 or an inactive keyword list 1703. In FIG. 17, the keywords “TRAILBLAZERS” and “MICROSOFT” have been entered as active keywords. The keyword “IRAQ” has been entered and placed in the inactive keyword list 1703. A keyword can be selected and shifted between the active keyword list 1702 and the inactive keyword list 1703. Keywords entered into the active keyword list 1702 are subsequently displayed in the horizontal axis as additional categories. Keywords entered into the inactive keyword list are saved for future usage. Settings can be saved or deleted.

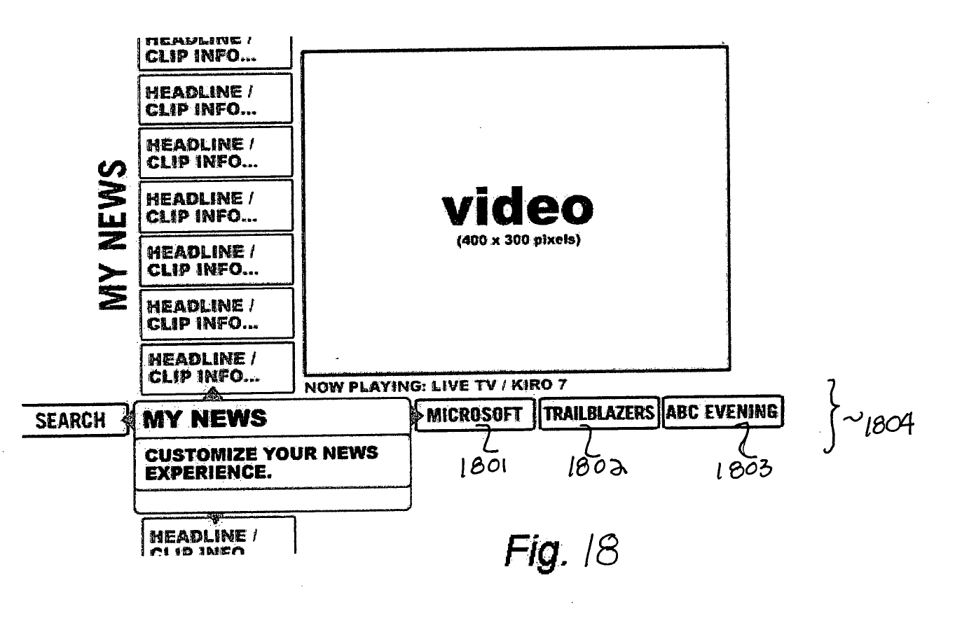

FIG. 18 is a block diagram illustrating the result of configuring a My News category to filter news for keywords. A new card 1801 that corresponds to the added keyword “MICROSOFT” and a new card 1802 that corresponds to the added keyword “TRAILBLAZERS” are displayed on the horizontal axis 1804. In one embodiment they are displayed between the My News category and the other categories or shows selected.

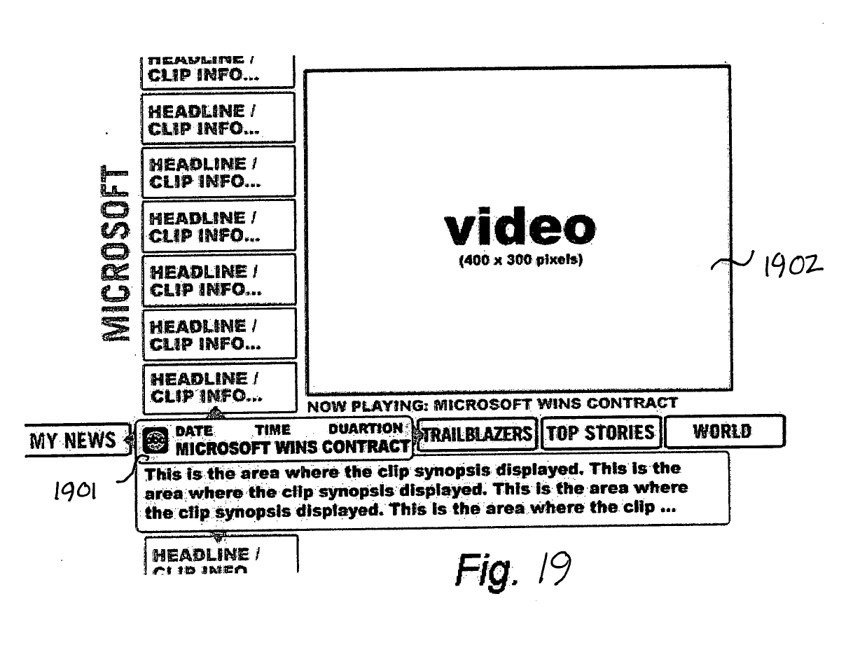

FIG. 19 is a block diagram illustrating a display of a user-defined category based upon a keyword. The new card 1801 from FIG. 18 has been moved into the center focus card position as card 1901. The card 1901 is shown in expanded form (Resting state) and represents one of the many available content segments having a keyword that matched the designated keyword: MICROSOFT. Selecting enter on this card will play the news video segment in the video window 1902. The vertical axis displays a list of news video segments that contain any mention of the keyword “MICROSOFT” as part of the news video segment's meta-data.

In one embodiment, an Auto Playlist feature is provided. As a default mode, any segment selected from a category's vertical menu (the vertical axis) will trigger a sequential playback of all the segments in the list in a hierarchy based on most recent date. The Auto Playlist feature is an infinite loop, which means if the News Browser is left on the My News category all day long, the latest segments encoded by the STB will be updated instantly into the list of available news video segments.

When the viewer selects play (by pressing Enter while the center focus card is in Resting state), the center focus card changes state to an Active state where abbreviated news video clip information is displayed. This minimized center focus card enables more screen real estate for video controls, for example those used to control the accelerated and decelerated feedback. These video controls allow the viewer to speed up or slow down the playback of the video clip without effecting the sound pitch of the audio track.

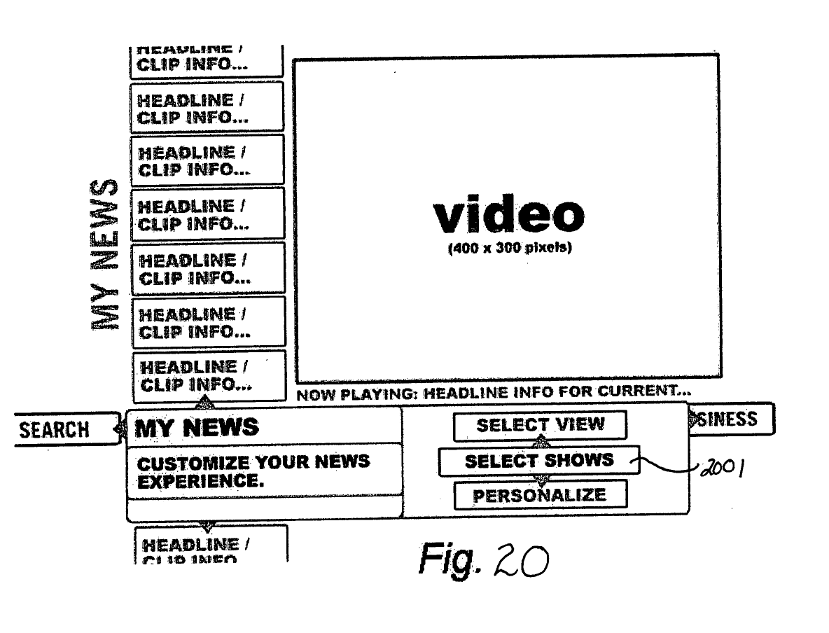

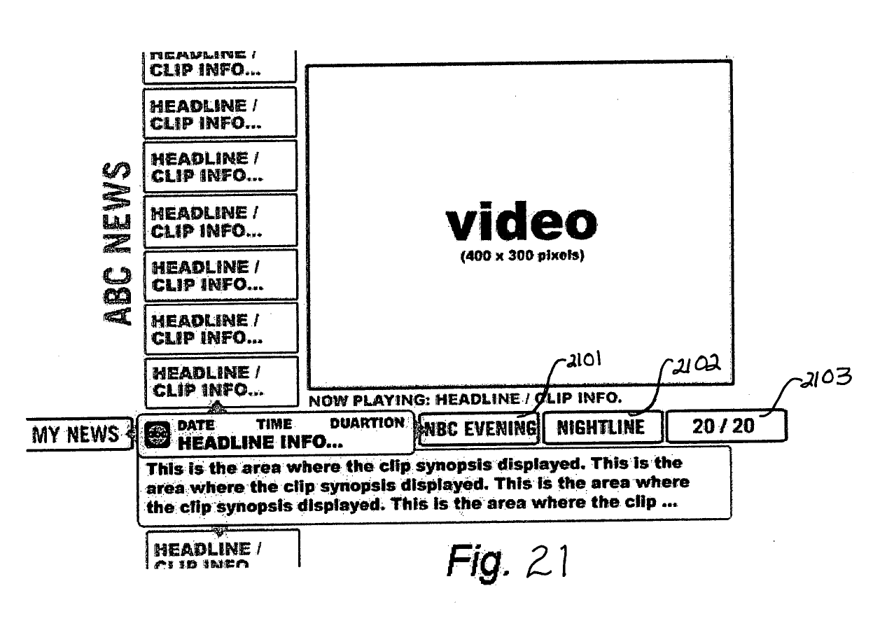

FIG. 20 is a block diagram illustrating results of customizing the My News category to display shows along the horizontal axis. FIG. 21 is a block diagram illustrating a resultant horizontal axis having three shows: “NBC Evening news” 2101, “Nightline” 2102, and “20/20” 2103. When a particular show is selected, the vertical axis displays the news segments available for that show. In one embodiment, configuration parameters can be selected for sorting orders.

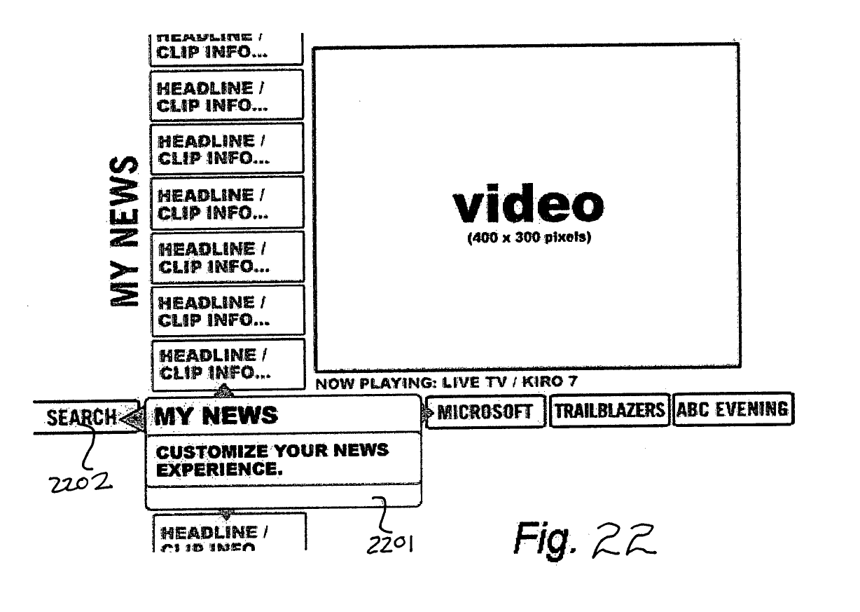

The view can also search for particular news content using a keyword (or other segment based meta-data) interface. FIG. 22 is an example block diagram of navigation for invoking a search capability. In the example shown, the viewer navigates to the Search function 2202 by browsing left from the My News category 2201.

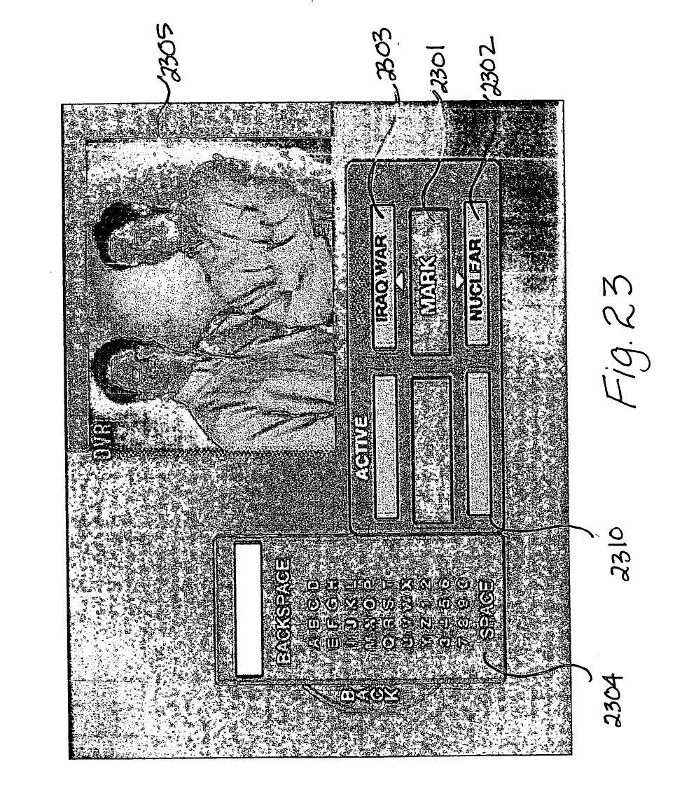

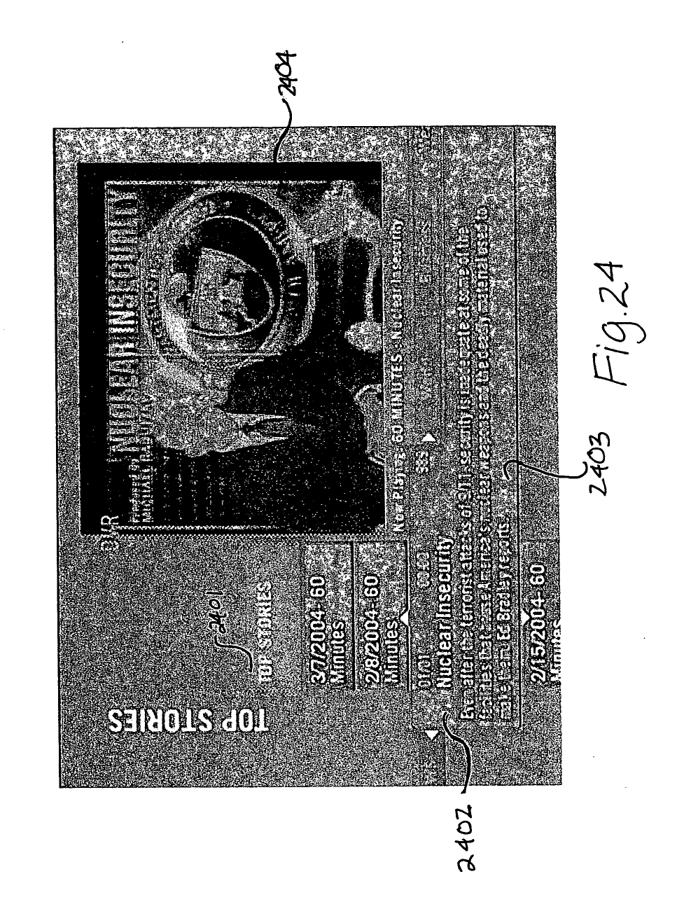

FIG. 23 is an example display screen of one interface used to implement a search capability. The viewer selects a keyword (or other meta-data if appropriate) from a list 2310 presented to indicate a search “filter.” In list 2310, three different keywords are currently displayed: “MARK” 2301, “NUCLEAR” 2302, and “IRAQ WAR” 2303. These may be by default the keywords previously available from the Active list used to configure My News. New keywords can be added by using the keypad 2304. If, for example, the “NUCLEAR” keyword 2302 is selected, then the display that results may be similar to FIG. 24. FIG. 24 shows a news segment that involves “Nuclear Insecurity” (keyword 2402) thus matching the designated filter. The video segment is shown in video window 2404, while a description of the segment is shown in expanded card 2403.

Other viewer interfaces for presenting search filter results are also contemplated. For example, a special user interface may be presented to allow the viewer to choose a video segment to play from a list of matching results before presenting the search results such as those shown in FIG. 24. Optionally the viewer could choose to view a highlighted portion (on the vertical axis) or all of the results (on the vertical axis).

FIG. 25 is an example block diagram of the use of meta-data information by an ECDS-enabled application to generate a display screen. In particular, FIG. 25 shows how the News Browser application incorporates particular fields in the user interface.

Other ECDS-Enabled Applications

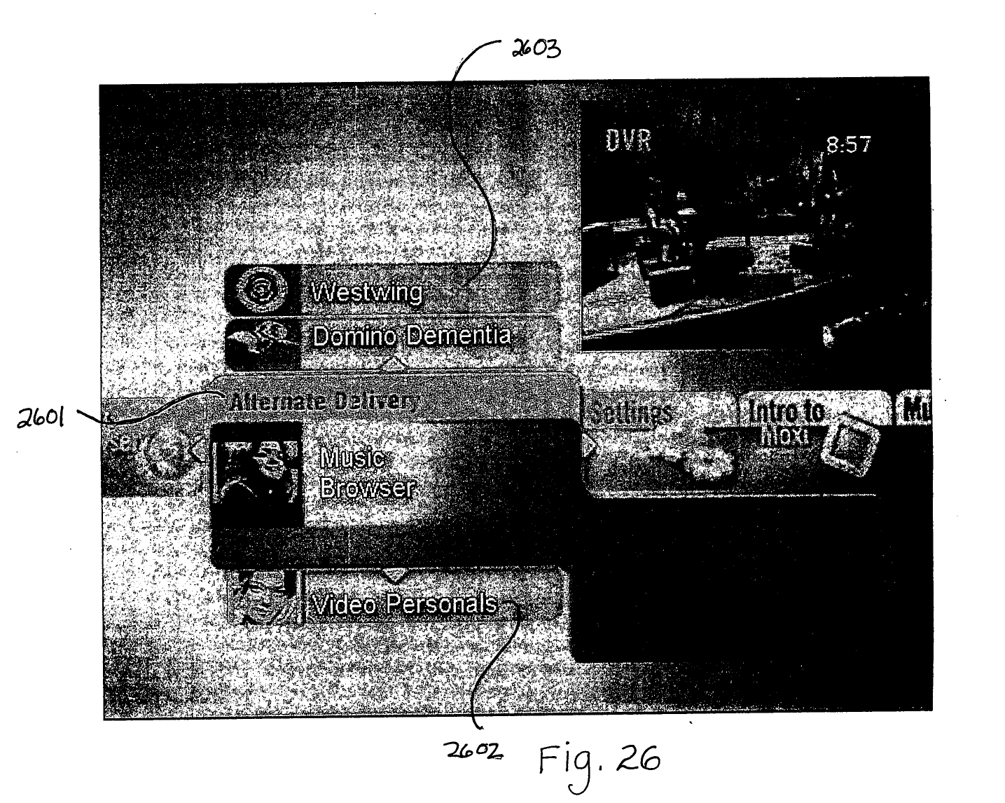

FIG. 26 is an example block diagram of a MOXI™ carded interface modified to enable selection of other ECDS-enabled applications. A viewer browses to Alternative Delivery card 2601 to select other applications such as a Music Browser. The viewer navigates to other applications via the vertical menu (the cards on the vertical axis).

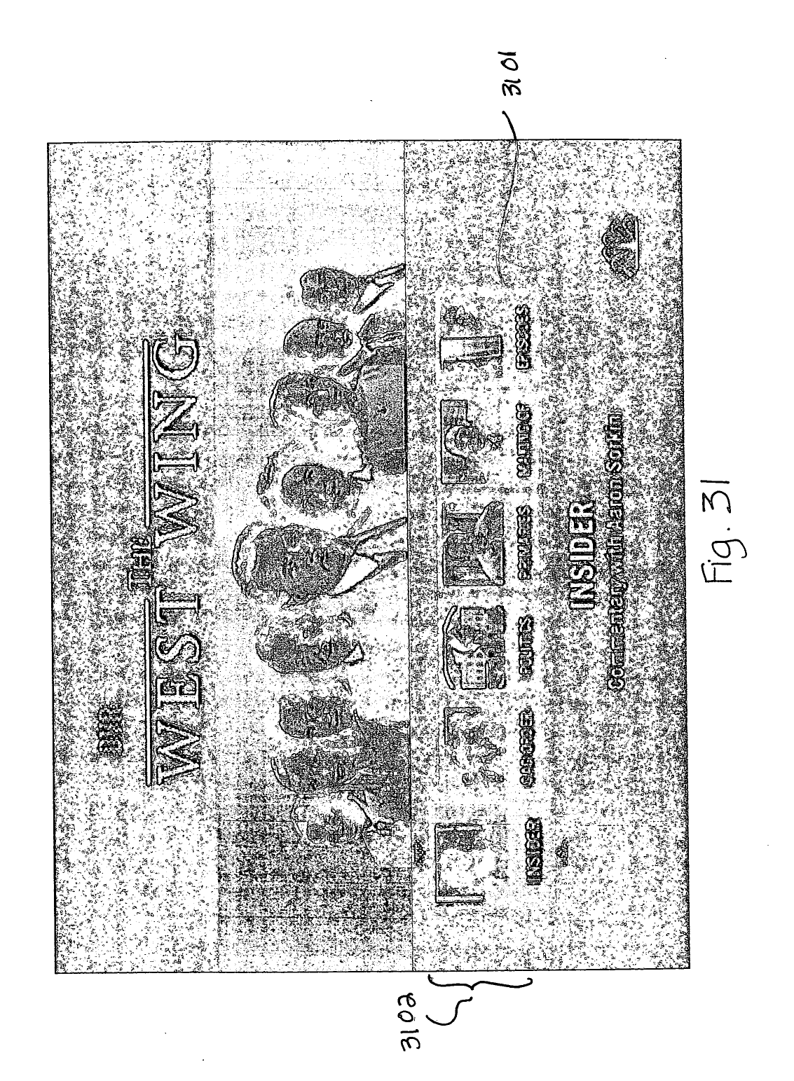

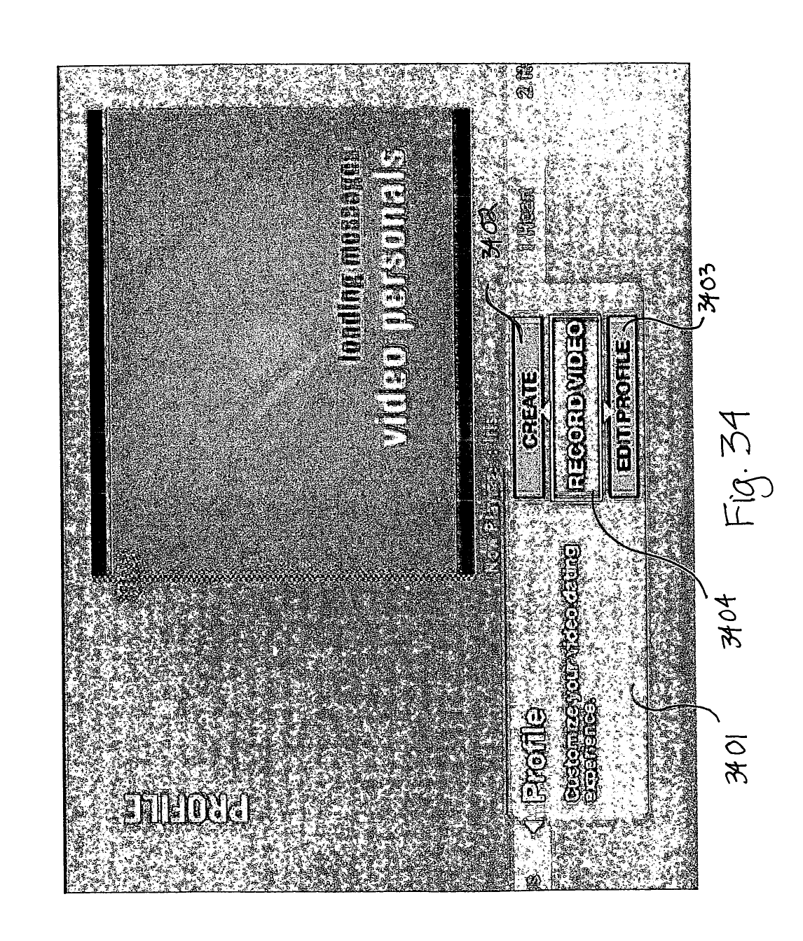

Note that the cards displayed in the vertical menu are merely representative of a few samples of integrated access to additional content. Access to other types of content is also contemplated. In card 2601, the viewer can select the Music Browser application described below, which is currently presenting Norah Jones (hence the minimized view of Norah Jones on the card). Other possibilities include alternate specific content, for example a group of (subscribed to) content, such as episodes relating to a particular television show 2602 (e.g., “Westwing”), as described below with respect to FIGS. 31-33. This alternate content is similar to content typically made available through a video store when buying a “boxed set” of episodes from the television show. Another possible application invoked from this interface is the Video Personals Browser described below with respect to FIGS. 34-36.

Music Browser

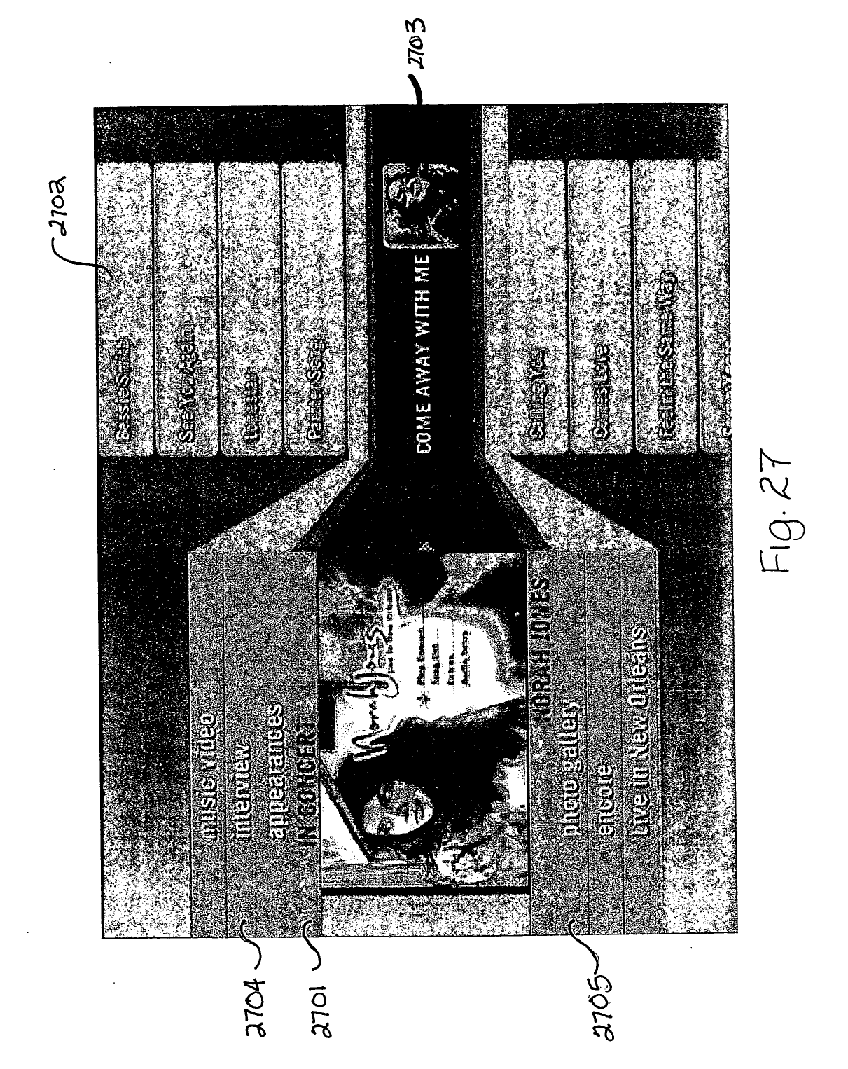

In one embodiment, an example music browser application that incorporates the techniques of the ECDS is provided. FIGS. 27-30 illustrate various aspects of a prototype Music Browser application integrated into a MOXI™ carded user interface.

The Music Browser application illustrates an example of combining recorded content with auxiliary content such as that described with respect to FIG. 6. The Music Browser combines recorded video and audio for music artists with related content from, for example, third party suppliers. Meta-data is associated with the recorded content by the IMDS in a similar manner to that used with the News Browser.

FIG. 27 shows an example display screen, after the viewer has browsed to the Music Browser application. A selected segment (song “Come Away with Me”) for the Norah Jones “Live in New Orleans” concert recording 2701 is currently playing as indicated by segment indicator 2703. Other segments available from that recording are shown in song list 2702. Other related content, such as interview clips 2704 and a photo gallery 2705 is also available for perusal.

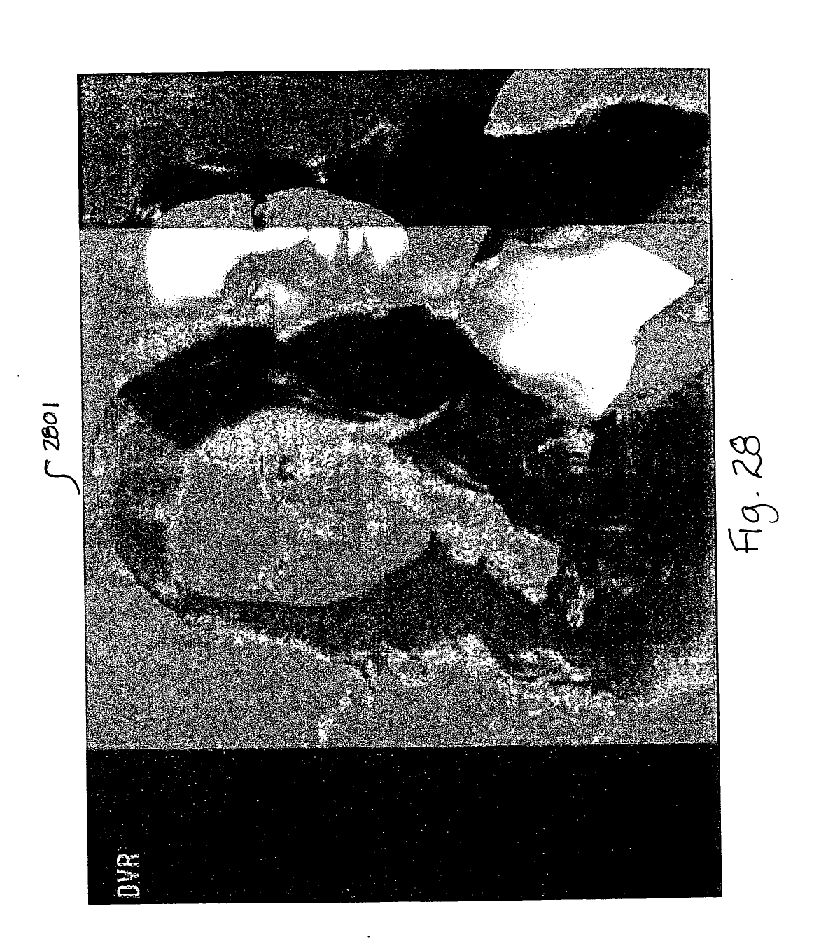

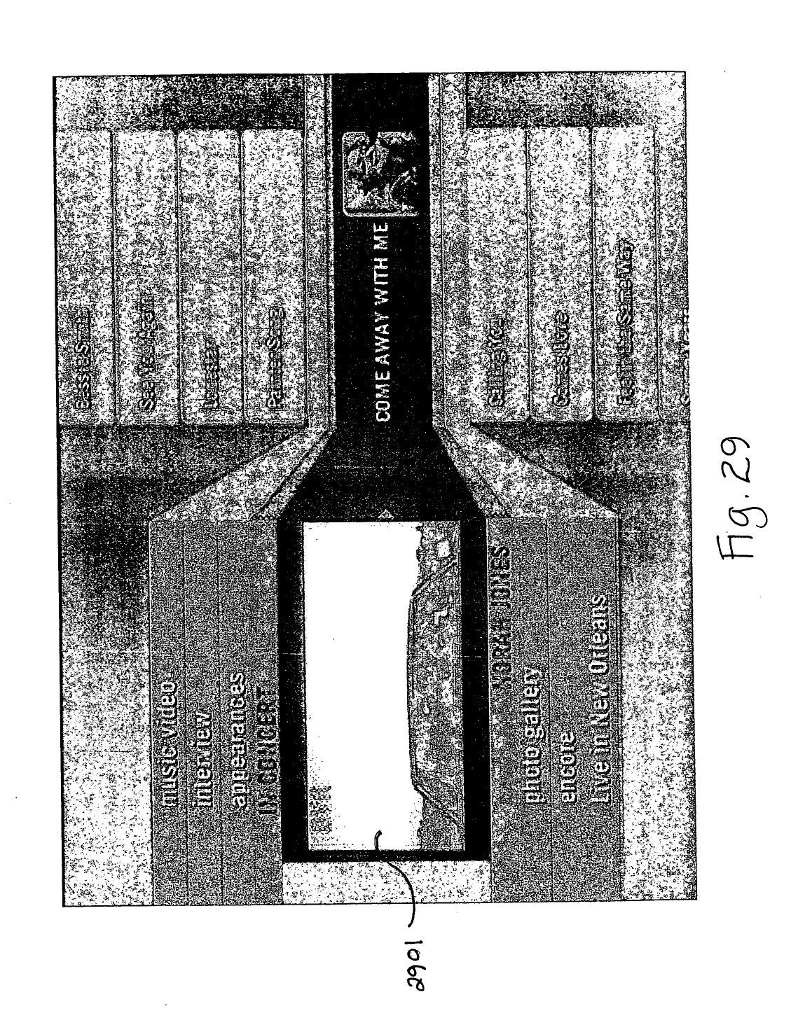

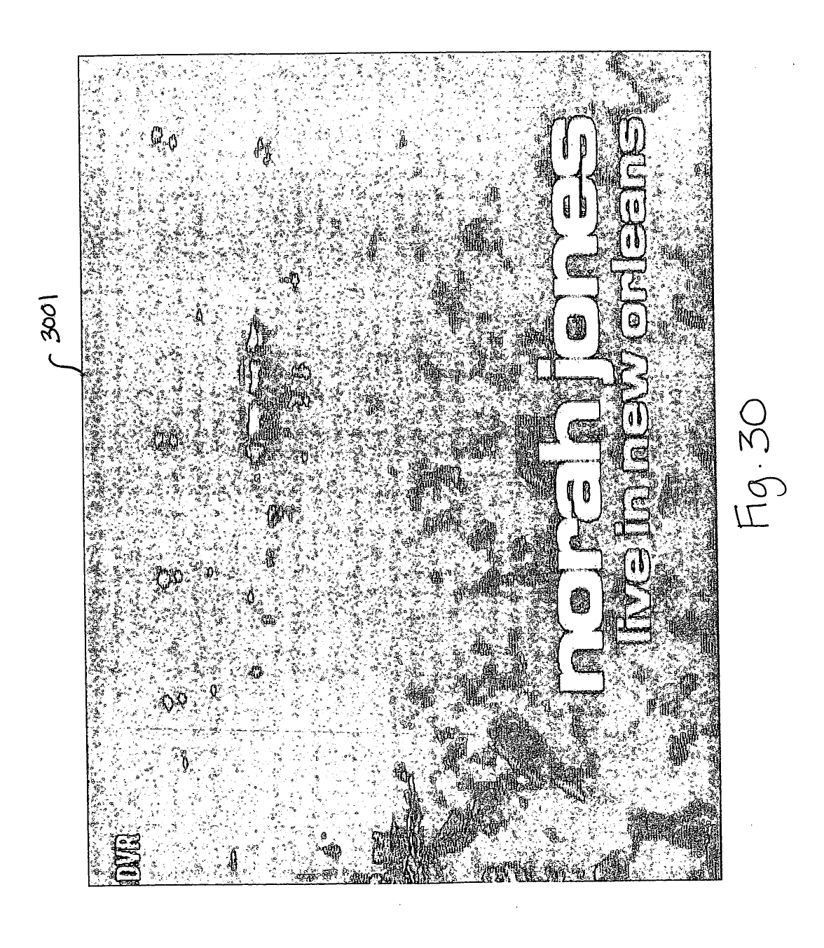

When a viewer selects the photo gallery 2705, a list of photos is displayed. FIG. 28 is an example display screen of a particular photo 2801 from the photo gallery related content. FIG. 29 shows a related video content segment 2901 that was prerecorded onto the DVR. The related video segment is presented to illustrate the current music segment being presented. FIG. 30 illustrates another type of related content. A video segment 3001 shows the crowd present at the concert that is presented as the current segment.

Other Auxiliary or Alternate Content

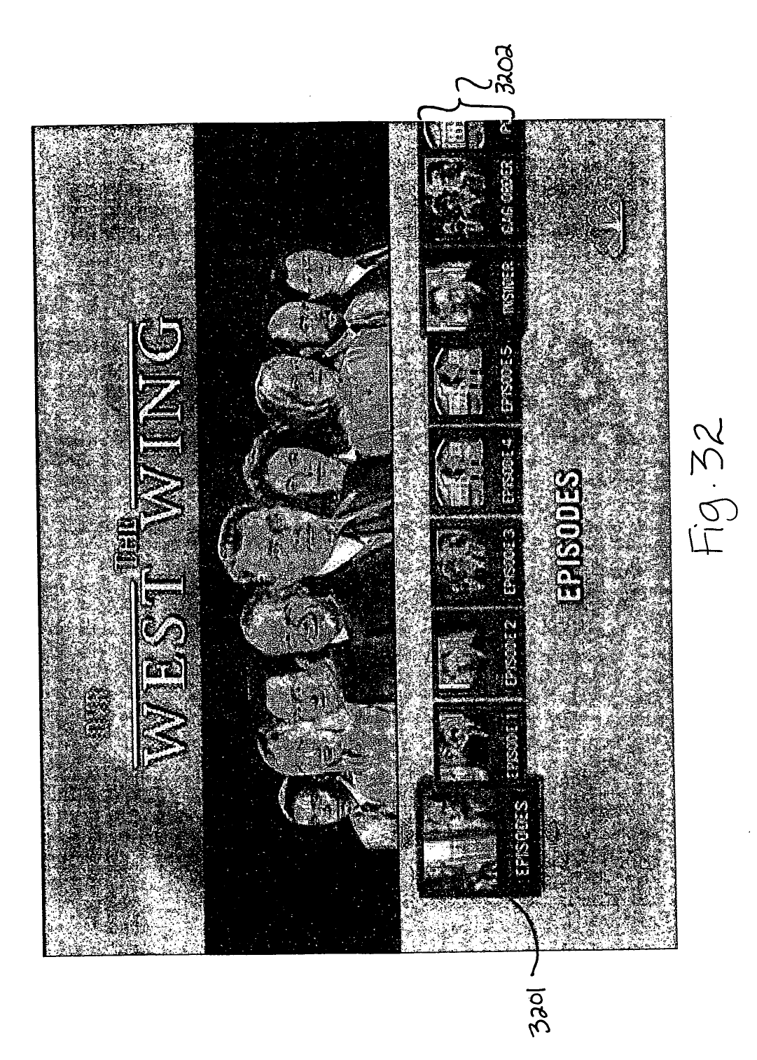

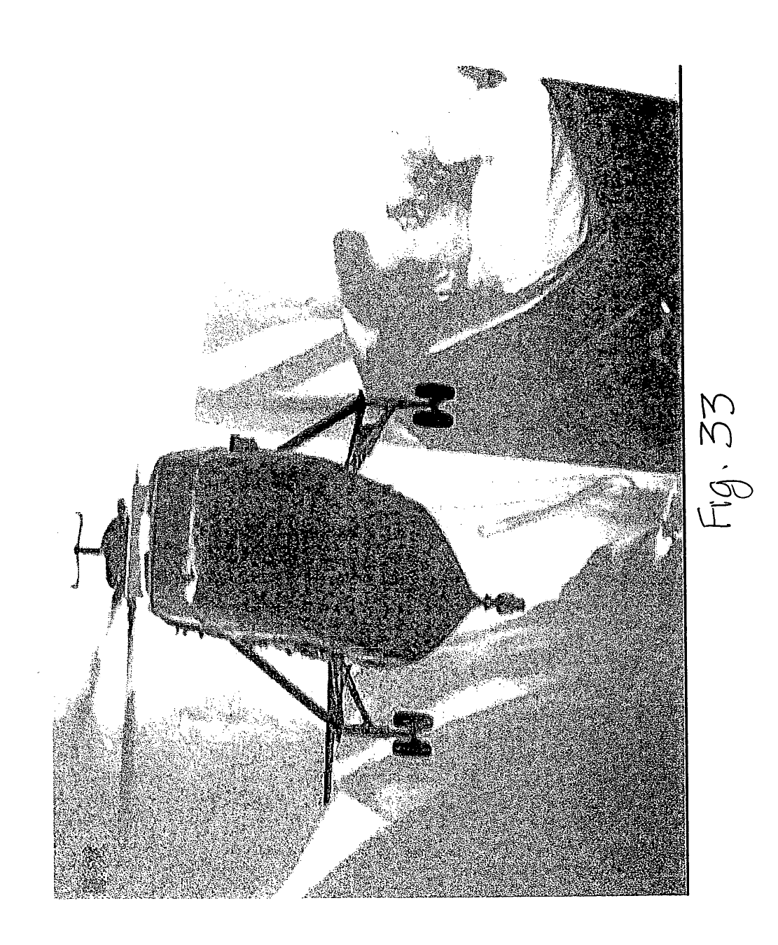

Many different applications can be envisioned for presenting alternate or auxiliary program content. Any such content can be made accessible using the Moxi™ interface using, for example an “Alternate Delivery” card shown in FIG. 26. FIGS. 31-33 illustrate various aspects of prototype auxiliary content integrated into a MOXI™ carded user interface. In particular, FIGS. 31-33 are example display screens from “The West Wing” alternate content browser. In FIG. 31, an icon list 3102 presents the auxiliary content that corresponds to the TV show, as well as a button 3101 that can be used to display episodes (previously recorded content segments) from the program. In FIG. 32, once the episodes button 3201 is selected, the viewer is presented with a plurality of episodes 3202 from which one can be chosen for viewing. These episodes can be segmented using techniques similar to those described above with respect to the News Browser and ECDS architecture. FIG. 33 is an example display screen showing an example content segment from one of the episodes.

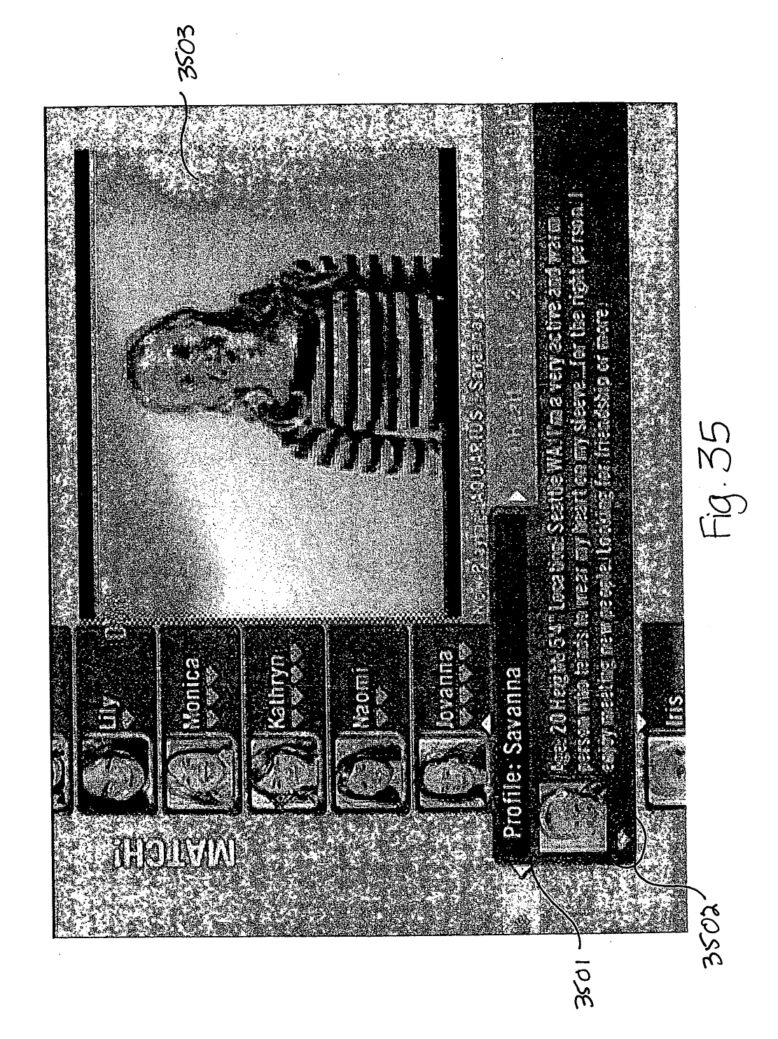

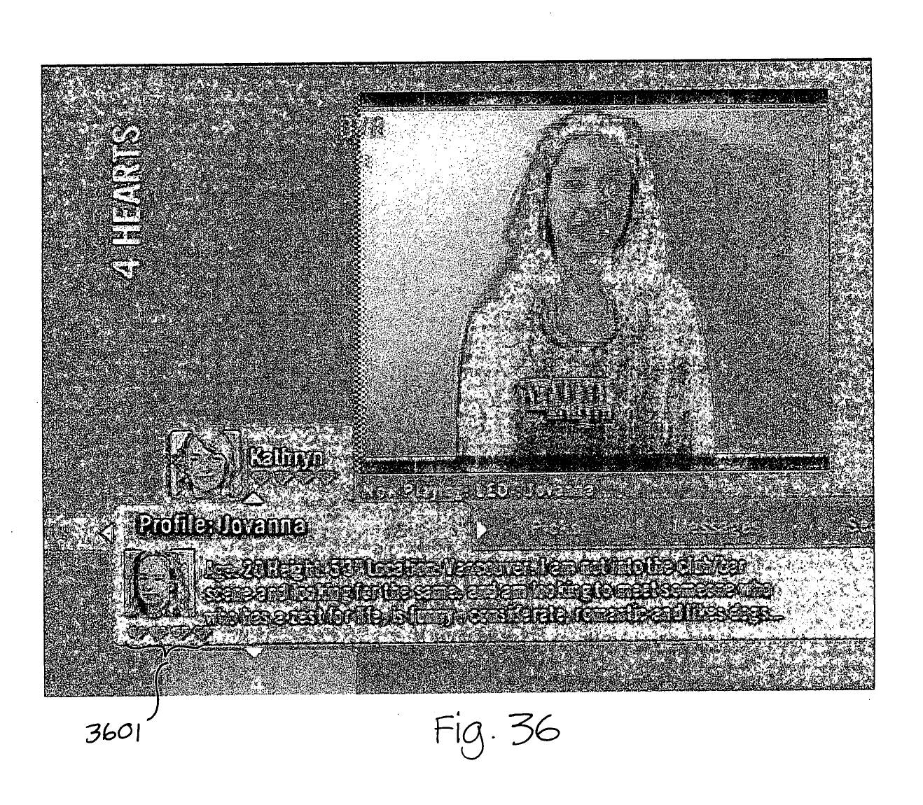

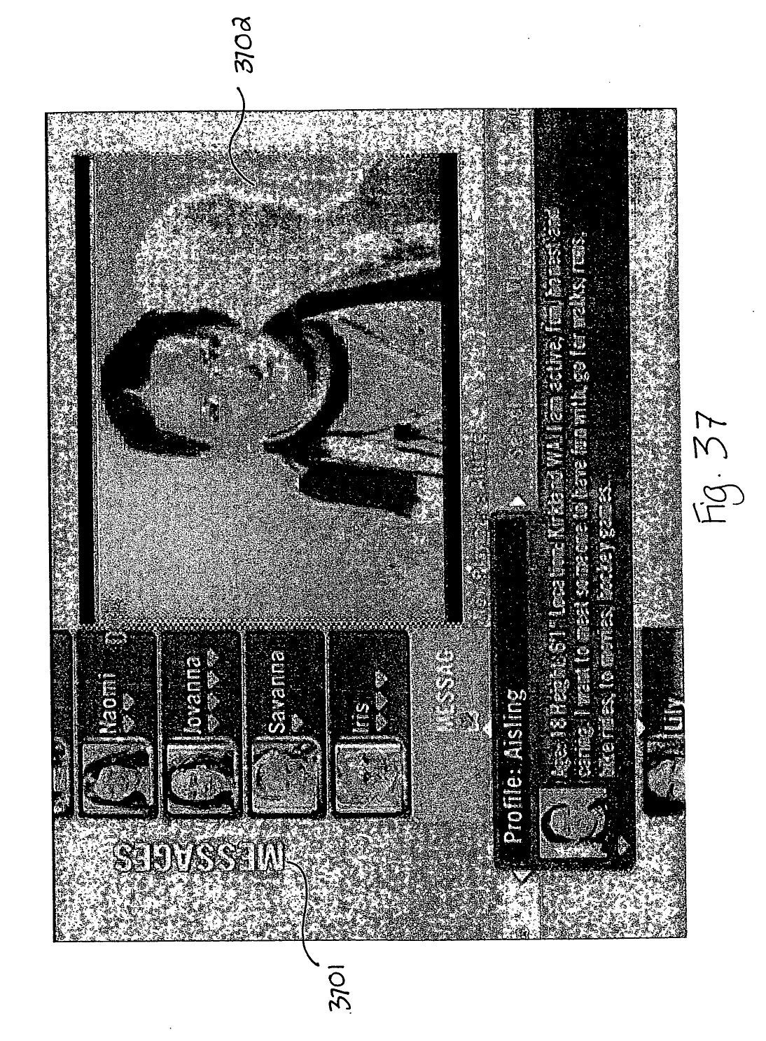

FIGS. 34-36 illustrate various aspects of a prototype Video Personals Browser integrated into a MOXI™ carded user interface. The Video Personals (VP) Browser allows each participant to define attributes and profile options, which are then translated to meta-data used to match up participants. FIG. 34 is an example interface for creating and managing a VP profile entry 3401. The viewer can create a new profile, edit a current profile, or record a video segment (optionally with an audio component) to be presented to other candidates using buttons 3402, 3403, and 3404, respectively. Once the participant defines a profile, the VP Browser selects potential matches using a “heart” scale—1 to 4 hearts indicates a good to better to best match. FIG. 35 is an example display screen for matching a candidate to the participant defined profile. The matching candidate's video is presented in video window 3503, a description of the matching candidate's profile is displayed in the selected card 3501, and a match rating 3502 is displayed in the profile (based upon the derived meta-data). FIG. 36 is an example display for a better matching candidate, whose rating based upon derived meta-data is shown in field 3601. FIG. 37 presents a communication message display 3701 that can be sent from one candidate to another as a result of finding a potential match. The message (audio and video) is displayed in video window 3702. Other alternative content, presentation, and organization is contemplated to be incorporated with the Video Personals Browser application as well as with the other applications.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/566,756, entitled “METHOD AND SYSTEM FOR THE MANAGEMENT AND NON-LINEAR PRESENTATION OF MULTIMEDIA CONTENT,” filed Apr. 30, 2004, is incorporated herein by reference, in its entirety.

Reference throughout this specification to “one embodiment,” “an example embodiment,” or “an embodiment” (or similar language) means that a particular feature, structure, or characteristic described in connection with the embodiment is included in at least one embodiment. Thus, the appearances of the phrases “in one embodiment,” “in an example embodiment,” or “in an embodiment” in various places throughout this specification are not necessarily all referring to the same embodiment. Furthermore, the particular features, structures, or characteristics may be combined in any suitable manner in one or more embodiments.

In addition, the described technique for performing presentation of linear programs using non-linear techniques discussed herein are applicable to architectures other than a set-top box architecture or architectures based upon the MOXI™ system. For example, an equivalent system and applications can be developed for other DVRs and STBs. The methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.) able to receive and record such content.

In the description, numerous specific details have been given to provide a thorough understanding of embodiments. The embodiments can be practiced without one or more of the specific details, or with other methods, components, materials, data formats, code flow, etc. In other instances, well-known structures, materials, or operations are not shown or described in detail to avoid obscuring aspects of the embodiments. Thus, it will be appreciated that, although specific embodiments of the invention have been described herein for purposes of illustration, various modifications may be made without deviating from the spirit and scope of the invention. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

1. A method in a digital video recording system for presenting streamed or broadcasted multimedia content in a non-linear manner, comprising:
receiving streamed or broadcasted multimedia content in a linear sequence from a content distribution source and recording the received content in a memory device associated with the digital video recording system;
determining a structure for categorizing the received content into segments;
segmenting the recorded content according to the determined structure into a plurality of content portions, each associated with an identifier;
determining and directly accessing from the memory device a content portion that is associated with a designated identifier; and
presenting the determined content portion such that the portion is presented out of order from the sequence in which the content portion was recorded.

2. The method of claim 1, the identifier associated with each content portion including at least one meta-data item, and wherein the determining and directly accessing from the memory recording device the content portion that is associated with the designated identifier, comprises:
receiving a designated value of the at least one meta-data item; and
determining and directly accessing from the memory device at least one content portion that is associated with the designated value of the at least one meta-data item.

3. The method of claim 1, further comprising:
receiving and storing a plurality of enhanced meta-data items;
associating the stored meta-data items with the segmented content;
receiving an indication of a value for one of the meta-data items;
determining and directly accessing from the memory device a content portion that corresponds to the indicated value for the one of the meta-data items; and
presenting the determined corresponding content portion in an order that differs from the sequence in which the determined content portion was recorded.

4. The method of claim 3 wherein the receiving and storing the plurality of enhanced meta-data items, comprises:
receiving and storing a plurality of enhanced meta-data items that include electronic programming guide (“EPG”) data.

5. The method of claim 3 wherein the receiving and storing the plurality of enhanced meta-data items comprises:
receiving and storing a plurality of enhanced meta-data items that correspond to at least one of a segment identifier, a start time, a date, a time, a duration, a logo, a title, a headline, a short description, a long description, a genre, a category, a show name, a keyword.

6. The method of claim 1, further comprising:
receiving and storing auxiliary content that corresponds to one or more of the content portions; and
when the determined at least one content portion that is associated with the designated identifier is presented, presenting the received auxiliary content that corresponds to the presented content portion.

7. The method of claim 6 wherein the presenting the received auxiliary content that corresponds to the presented content portion comprises:
presenting the received auxiliary content that corresponds to the presented content portion according to a set of business rules and logic associated with the content portion.

8. The method of claim 1 wherein the content distribution source is one of a head end for broadcast media, a source for video-on-demand, a source for Internet content, or a source of streamed network content.

9. The method of claim 1 wherein the determining the structure for categorizing the received content into segments and the segmenting the stored content according to the determined structure is specific to the sequence of the received content.

10. The method of claim 1, the presented content portion having an associated audio component, further comprising:
presenting the content portion at an accelerated or decelerated speed while preserving perceived quality of sound produced by the associated audio component.

11. A computer readable memory medium containing content that enables a personal video recording system to present streamed or broadcasted multimedia content in a non-linear manner by performing:
receiving streamed or broadcasted multimedia content in a linear sequence from a content distribution source and recording the received content in a memory device associated with the personal video recording system;
determining a structure for categorizing the received content into segments;
segmenting the recorded content according to the determined structure into a plurality of content portions, each associated with an identifier;
determining and directly accessing from the memory device a content portion that is associated with a designated identifier; and
presenting the determined content portion such that the portion is presented out of order from the sequence in which the content portion was recorded.

12. The memory medium of claim 11, wherein each identifier is associated with at least one meta-data item, and further containing content that enables the personal video recording system to present streamed or broadcasted multimedia content by performing:
receiving a designated value of the at least one meta-data item; and
determining and directly accessing from the memory device at least one content portion that is associated with the designated value of the at least one meta-data item.

13. The memory medium of claim 11, further containing content that enables the personal video recording system to present streamed or broadcasted multimedia content by performing:
receiving and storing a plurality of enhanced meta-data items;
associating the stored meta-data items with the segmented content;
receiving an indication of a value for one of the meta-data items;
determining and retrieving from the memory device a content portion that corresponds to the indicated value for the one of the meta-data items; and
presenting the determined corresponding content portion in an order that differs from the sequence in which the determined content portion was recorded.

14. The memory medium of claim 13 wherein the plurality of enhanced meta-data items comprise at least one of EPG data, a segment identifier, a start time, a date, a time, a duration, a logo, a title, a headline, a short description, a long description, a genre, a category, a show name, a keyword.

15. The memory medium of claim 11, further containing content that enables the personal video recording system to present streamed or broadcasted multimedia content by performing:
receiving and storing auxiliary content that corresponds to at least one content portion; and
when the determined at least one content portion that is associated with the designated identifier is presented, presenting the received auxiliary content that corresponds to the presented content portion.

16. The memory medium of claim 11 wherein the content distribution source is one of a head end for broadcast media, a source for video-on-demand, a source of streamed Internet content, or a source of streamed network content.

17. The memory medium of claim 11, the presented content portion having an associated audio component, further containing content that enables the personal video recording system to present streamed or broadcasted multimedia content by performing:
presenting the content portion at an increased or decreased speed while preserving perceived quality of sound produced by the associated audio component.

18. An enhanced content delivery system configured to present streamed or broadcasted multimedia content in a non-linear manner, comprising:
a display;
a video recording device configured to receive streamed or broadcasted multimedia content from a content distribution source and to record the received content in a linear sequence;
a meta-data component configured to receive and segment the recorded content into a plurality of portions and to generate and store meta-data items associated with the content portions; and
an enhanced data content manager configured to
receive a designated value for at least one of the meta-data items,
determine and retrieve from the video recording device at least one content portion that is associated with a meta-data item that matches the designated value, and
present on the display the retrieved content portion without regard to an order the content portion appears in the linear sequence.

19. The content delivery system of claim 18 wherein the meta-data items comprise at least one of EPG data, a segment identifier, a start time, a date, a time, a duration, a logo, a filename, a title, a headline, a description, a genre, a category, a show name, a keyword.

20. The content delivery system of claim 18, further comprising:
an auxiliary content component configured to receive and store auxiliary content that corresponds to one or more of the content portions and wherein the enhanced data content manager is further configured to present on the display auxiliary content that corresponds to the presented content portion.

21. The content delivery system of claim 18 wherein the content distribution source is one of a head end for broadcast media, a source for video-on-demand, a source for Internet content, or a source of streamed network content.

22. The content delivery system of claim 18 wherein the enhanced data content manager is further configured to present the retrieved content portion at an accelerated or decelerated speed while preserving perceived quality of sound produced by an audio component associated with the retrieved content portion.
